(19) United States
(12) Patent Application Publication
(10) Pub. No.: US 2007/0046584 A1
(43) Pub. Date: Mar. 1, 2007

(54) Apparatus and method for driving plasma display panel

(76) Inventors: Hai Young Jung, Incheon-si (KR); Byung Nam Ahn, Seoul (KR)

Correspondence Address: FLESHNER & KIM, LLP, P.O. BOX 221200, CHANTILLY, VA, 20153, US

(21) Appl. No.: 11/509,065

(22) Filed: Aug. 24, 2006

(30) Foreign Application Priority Data
Aug. 25, 2005 (KR) 10-2005-0078489
Sep. 29, 2005 (KR) 10-2005-0091355
Oct. 24, 2005 (KR) 10-2005-0100159

(51) Int. Cl. G09G 3/28

(52) U.S. Cl. 345/68

(57) ABSTRACT

An apparatus and a method for driving a plasma display panel are disclosed. The driving apparatus includes a voltage source, a capacitor charged with a voltage supplied from the voltage source, or discharging the charged voltage, a first switching unit for performing a switching operation to apply the voltage from the voltage source to the capacitor and a panel, or to apply the charged voltage from the capacitor to the panel, and a second switching unit for performing a switching operation reverse to the switching operation of the first switching unit, to discharge a voltage from the panel and to discharge the charged voltage from the capacitor, or to apply the voltage from the voltage source to the capacitor and to discharge the voltage from the panel.

This application claims the benefit of Korean Patent Application No. 10-2005-0078489 filed on Aug. 25, 2005, 10-2005-0091355 filed on Sep. 29, 2005, 10-2005-0100159, filed on Oct. 24, 2005, which is hereby incorporated by reference as if fully set forth herein.

### BACKGROUND OF THE INVENTION

1. Field of the Invention

The present invention relates to a plasma display panel, and more particularly to an apparatus and a method for driving a plasma display panel using a half sustain driving scheme.

2. Discussion of the Related Art

Generally, plasma display panels are known as a display device in which vacuum ultraviolet (VUV) rays generated in accordance with gas discharge carried out in the interior of a panel strike phosphors on an inner surface of the panel, thereby generating light. Such a plasma display panel mainly includes a front substrate 1 and a back substrate 3, as shown in FIG. 1.

The plasma display panel also includes a scan electrode and a sustain electrode which are designated by the same reference numeral, namely, “4”, in FIG. 1. The scan and sustain electrodes 4 are formed on the front substrate 1. The plasma display panel further includes a dielectric layer 6 laminated over the scan and sustain electrodes 4, and a dielectric protection layer 8 formed over the dielectric layer 6.

Each of the scan and sustain electrodes 4 is composed of a transparent electrode 4a having a relatively large width, and a bus electrode 4b having a relatively small width. The transparent electrode 4a is made of a transparent electrode material such as indium tin oxide (ITO), to allow visible rays to pass through the transparent electrode 4a. The bus electrode 4b is made of a metal material, and adapted to compensate for a surface resistance of the transparent electrode 4a.

When a drive signal for driving the plasma display panel is supplied to the scan and sustain electrode 4, wall charge is accumulated in the dielectric layer 6. The dielectric protection layer 8 prevents the dielectric layer 6 from being damaged due to sputtering, and enhances an efficiency of discharging secondary electrons.

An address electrode 5 is formed on the back substrate 3 such that the address electrode 5 extends orthogonally to the scan and sustain electrodes 4. A dielectric layer 7 is formed over the address electrode 5. The dielectric layer 7 functions to accumulate wall charge.

A barrier rib 2 is formed on the dielectric layer 7, to define a discharge space. A phosphor layer 9 is coated over side surfaces of the barrier rib 2 and a surface of the dielectric layer 7 corresponding to a bottom of the discharge space. The phosphor layer 9 is excited by ultraviolet rays generated during plasma discharge, thereby emitting visible rays of red, green, or blue.

Practically, the plasma display panel displays an image in accordance with a discharge occurring between a plurality of address electrodes X arranged in columns and a plurality of scan electrodes Y and sustain electrodes Z arranged in rows.

As shown in FIG. 2, the plasma display panel is driven in accordance with a driving waveform basically providing a reset period R, an address period A, and a sustain period S. In the reset period R, a setup reset signal R_up and a setdown reset signal R_dn are continuously supplied.

When the setup reset signal R_up is supplied, a reset discharge is generated between the scan electrodes Y and the sustain electrodes Z. As a result, wall charge is accumulated in the dielectric layer on the scan electrodes Y and sustain electrodes Z. On the other hand, when the setdown reset signal R_dn is supplied, the wall charge accumulated in discharge cells is erased, to secure a desired operation margin of the driving circuit.

A positive (+) data pulse according to image data is applied to the address electrode X in an address period A. In the address period A, a negative (−) scan pulse opposite to the data pulse is also applied to the scan electrode Y. In the cell associated with the application of the data pulse, an address discharge occurs due to a voltage difference between the data pulse and the scan pulse.

In a sustain period S, sustain pulses are alternately supplied to the scan electrode Y and the sustain electrode Z. When a sustain pulse is supplied to the cell where an address discharge has occurred, a sustain discharge occurs. Thus, an image is displayed.

The difference between high and low voltage levels of the sustain pulse supplied to the scan electrode Y or sustain electrode Z in the sustain period S is referred to as a sustain voltage Vs. Where the low and high voltage levels of the sustain pulse correspond to half of the sustain voltage Vs, namely, Vs/2, this driving method is called a “half sustain driving scheme”.

In accordance with the half sustain driving scheme, the low-level voltage of the sustain pulse is not a ground voltage, but a negative (−) voltage, and has a level corresponding to half of the sustain voltage Vs, namely, Vs/2.

Referring to FIG. 2, reset signals are shown which are applied to the scan electrode Y for a reset period R. The setup reset signal R_up ascends from a ground level GND to about half of the sustain voltage Vs, namely, Vs/2, and then further ascends to 100 to 150V in the form of a ramp waveform. The setdown reset signal R_dn descends to about half of the sustain voltage Vs, namely, Vs/2, and then further descends to about −300 V in the form of a ramp waveform.

A scan voltage Vsc is applied to the scan electrode Y in an address period A. The application of the scan voltage Vsc is carried out under the condition in which the setdown reset signal R_dn has a minimum voltage level of −Vy.

When a data pulse dp according to image data is applied to the address electrode X, a scan pulse opposite to the data pulse is applied to the scan electrode. In accordance with the application of the scan pulse, the voltage of the scan electrode is reduced to a level of −Vy.

When a sustain period S is begun, sustain pulses are alternately applied to the scan electrode Y and the sustain electrode Z. The sustain pulses have a voltage level ascending from the ground level GND by “Vs/2” in a positive direction, and descending from the ground level GND by “Vs/2” in a negative direction.

In accordance with the half sustain driving scheme, wall charge is formed in the scan electrode Y and the sustain electrode Z, similarly to conventional cases in which a sustain discharge is carried out in accordance with repeated ascending/descending of sustain pulses from the ground voltage level to the sustain voltage level.

In addition, the electric field, which is formed between the scan electrode Y and the address electrode X or between the sustain electrode Z and the address electrode X when a discharge occurs between the scan electrode Y and the sustain electrode Z during the sustain period S, is weaker that those of conventional cases. Accordingly, formation of latent images is reduced. Also, an improvement in efficiency is achieved.

In order to drive a plasma display panel in accordance with the half sustain driving scheme, however, it is necessary to use separate voltage sources for supplying a positive sustain voltage component of Vs/2 and a negative sustain voltage component of −Vs/2.

Use of such separate voltage sources for supplying a positive sustain voltage component of Vs/2 and a negative sustain voltage component of −Vs/2 causes a complex and expensive configuration of the power supply for supplying desired voltages to the plasma display panel.

For this reason, it is necessary to provide a circuit configuration capable of supplying both the positive sustain voltage component of Vs/2 and the negative sustain voltage component of −Vs/2 using a single voltage source, for application of sustain pulses.

However, where such a circuit using a single voltage source is configured, it is necessary to use switches of a number corresponding to two times or more the number of switches required in conventional cases using the half sustain driving scheme. As a result, there is a problem of an increase in the costs required to configure the circuit.

The increased number of switches causes complicated control for ON/OFF of the switches. This causes a complex configuration of gate drive terminals of FETs used for the switches. As a result, a degradation in reliability and efficiency occurs.

In particular, when the number of switches, through which current passes, is increased, noise or distortion is generated at the waveform applied to the scan electrode Y or sustain electrode Z. Therefore, it is desirable to reduce the number of switches, in order to achieve an efficient and reliable half sustain driving operation using a single voltage source.

### SUMMARY OF THE INVENTION

Accordingly, the present invention is directed to an apparatus and a method for driving a plasma display panel that substantially obviate one or more problems due to limitations and disadvantages of the related art.

An object of the present invention is to provide an apparatus and a method for driving a plasma display panel, which are capable of simplifying circuits required for the driving of the plasma display panel, thereby achieving an enhancement in the reliability and efficiency of the circuits.

Another object of the present invention is to provide an apparatus and a method for driving a plasma display panel, which are capable of reducing power consumption required for the driving of the plasma display panel, thereby achieving an enhancement in energy efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for driving a plasma display panel, comprises: a voltage source; a capacitor charged with a voltage supplied from the voltage source, or discharging the charged voltage; a first switching unit for performing a switching operation to apply the voltage from the voltage source to the capacitor and a panel, or to apply the charged voltage from the capacitor to the panel; and a second switching unit for performing a switching operation reverse to the switching operation of the first switching unit, to discharge a voltage from the panel and to discharge the charged voltage from the capacitor, or to apply the voltage from the voltage source to the capacitor and to discharge the voltage from the panel.

The voltage supplied from the voltage source may be +½ of a sustain voltage. The capacitor may be charged with and may discharge a voltage corresponding to ±½ of the sustain voltage.

In another aspect of the present invention, an apparatus for driving a plasma display panel, comprises: a voltage source; a first switch for performing a switching operation to apply a voltage from the voltage source to a panel; a capacitor charged with a voltage supplied from the voltage source in accordance with the switching operation of the first switch; and a second switch and a third switch for performing a switching operation reverse to the switching operation of the first switch, to discharge a voltage from the panel and to discharge the charged voltage from the capacitor.

In another aspect of the present invention, an apparatus for driving a plasma display panel, comprises: a voltage source; a first switch for performing a switching operation to apply a negative voltage from the voltage source to a panel; a capacitor charged with a positive voltage in accordance with the switching operation of the first switch; and a second switch and a third switch for performing a switching operation reverse to the switching operation of the first switch, to apply the charged voltage from the capacitor to the panel.

In another aspect of the present invention, an apparatus for driving a plasma display panel, comprises: a voltage source; a first capacitor and a second capacitor charged with a voltage supplied from the voltage source, or discharging the charged voltage; a first switching unit for performing a switching operation to apply the voltage from the voltage source and the charged voltage from the first capacitor to a panel, or to apply the voltage from the voltage source to the second capacitor; and a second switching unit for performing a switching operation reverse to the switching operation of the first switching unit, to discharge a voltage from the panel and to discharge the charged voltage from the second capacitor, or to apply the voltage from the voltage source to the first capacitor.

The voltage supplied from the voltage source may be ±¼ of a sustain voltage. Each of the first and second capacitors may be charged with and may discharge a voltage corresponding to ±¼ of the sustain voltage.

In another aspect of the present invention, an apparatus for driving a plasma display panel, comprises: a first voltage source and a second voltage source; a first capacitor charged with a voltage supplied from the second voltage source, or discharging the charged voltage; a second capacitor charged with a voltage supplied from the first voltage source, or discharging the charged voltage; a first switching unit for performing a switching operation to apply the voltage from the first voltage source and the charged voltage from the first capacitor to a panel, or to apply the voltage from the first voltage source to the second capacitor; and a second switching unit for performing a switching operation reverse to the switching operation of the first switching unit, to discharge a voltage from the panel and to discharge the charged voltage from the second capacitor, or to apply the voltage from the second voltage source to the first capacitor.

The voltage supplied from each of the first and second voltage sources may be ±¼ of a sustain voltage. Each of the first and second capacitors may be charged with and discharges a voltage corresponding to ±¼ of the sustain voltage.

In another aspect of the present invention, a method for driving a plasma display panel using a plasma display panel driving apparatus including a first switch, a second switch, and a third switch electrically connected between the panel and a voltage source comprises: turning on the first switch, and turning off the second switch and the third switch, to apply a maximum voltage of a sustain pulse to the panel and to charge the capacitor; and turning off the first switch, and turning on the second switch and the third switch, to apply a minimum voltage of the sustain pulse to the panel and to discharge the voltage of the capacitor.

In another aspect of the present invention, a method for driving a plasma display panel using a plasma display panel driving apparatus including a first switch, a second switch, and a third switch electrically connected between the panel and a voltage source comprises: turning on the first switch and the second switch, and turning off the third switch, to apply a maximum voltage of a sustain pulse to the panel and to discharge a voltage from the capacitor; and turning off the first switch and the second switch, and turning on the third switch, to apply a minimum voltage of the sustain pulse to the panel and to charge the capacitor.

In still another aspect of the present invention, a method for driving a plasma display panel using a plasma display panel driving apparatus including a first switch, a second switch, a third switch, a fourth switch, a first capacitor, and a second capacitor electrically connected between the panel and a voltage source, comprises: turning on the first switch and the second switch, and turning off the third switch and the fourth switch, to discharge a voltage from the first capacitor and to charge the second capacitor, thereby applying a maximum voltage of a sustain pulse to the panel; and turning off the first switch and the second switch, and turning on the third switch and the fourth switch, to charge the first capacitor and to discharge a voltage from the second capacitor, thereby applying a minimum voltage of the sustain pulse to the panel.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view schematically illustrating a structure of a general plasma display panel;

FIG. 2 is a waveform diagram of signals applied to drive the plasma display panel of FIG. 1;

FIG. 3 is a block diagram for explaining a method for driving a plasma display panel in accordance with the present invention;

FIG. 4 is a circuit diagram illustrating an apparatus for driving a plasma display panel in accordance with a first embodiment of the present invention;

FIG. 5 is a timing diagram illustrating ON/OFF timings of switches shown in FIG. 4;

FIG. 6 is a circuit diagram illustrating an apparatus for driving a plasma display panel in accordance with a second embodiment of the present invention;

FIGS. 7A and 7B are circuit diagrams illustrating current paths of FIG. 6;

FIG. 8 is a circuit diagram illustrating an apparatus for driving a plasma display panel in accordance with a third embodiment of the present invention;

FIGS. 9A to 9F are waveform diagrams of drive signals associated with constituent elements shown in FIG. 8;

FIG. 10 is a circuit diagram illustrating a current path in a sustain-down period SDP;

FIG. 11 is a circuit diagram illustrating a current path in a sustain-up period SUP;

FIG. 12 is a circuit diagram illustrating an apparatus for driving a plasma display panel in accordance with a fourth embodiment of the present invention;

FIGS. 13 to 16 are circuit diagrams for explaining operation of the PDP driving apparatus shown in FIG. 12;

FIG. 17 is a circuit diagram illustrating a practical example of the PDP driving apparatus according to the present invention shown in FIG. 12;

FIG. 18A is a waveform diagram of sustain pulses generated by the PDP driving apparatus of FIG. 17 according to the present invention;

FIG. 18B is a waveform diagram of resonance current generated in the PDP driving apparatus of FIG. 17 according to the present invention;

FIG. 19 is a circuit diagram illustrating an apparatus for driving a plasma display panel in accordance with a fifth embodiment of the present invention;

FIG. 20A is a timing diagram of turn-on and turn-off states of the switches shown in FIG. 19;

FIG. 20B is a waveform diagram of signals output in accordance with the timings of FIG. 20A;

FIGS. 21A and 21B are circuit diagrams illustrating voltage supply paths of the sustain driver in the PDP driving apparatus according to the fifth embodiment of the present invention;

FIG. 22 is a circuit diagram illustrating a modified embodiment of the PDP driving apparatus according to the fifth embodiment of the present invention;

FIGS. 23A to 23D are circuit diagrams for explaining the operation characteristics of the modified embodiment of the PDP driving apparatus according to the fifth embodiment of the present invention;

FIG. 24 is a circuit diagram illustrating a PDP driving apparatus according to a sixth embodiment of the present invention;

FIG. 25A is a timing diagram of turn-on and turn-off states of the switches shown in FIG. 24;

FIG. 25B is a waveform diagram of signals output in accordance with the timings of FIG. 25A;

FIGS. 26A and 26B are circuit diagrams illustrating voltage supply paths of the sustain driver in the PDP driving apparatus according to the sixth embodiment of the present invention;

FIG. 27 is a circuit diagram illustrating a modified embodiment of the PDP driving apparatus according to the sixth embodiment of the present invention; and

FIGS. 28A to 28D are circuit diagrams for explaining the operation characteristics of the modified embodiment of the PDP driving apparatus according to the sixth embodiment of the present invention.

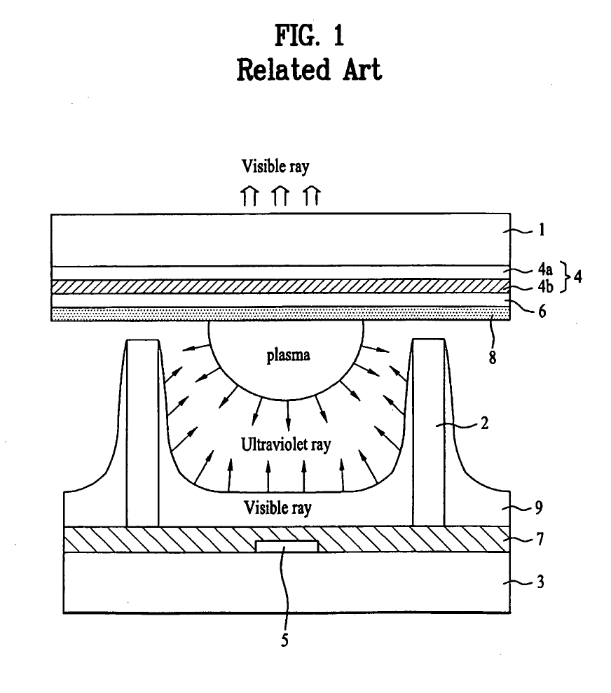

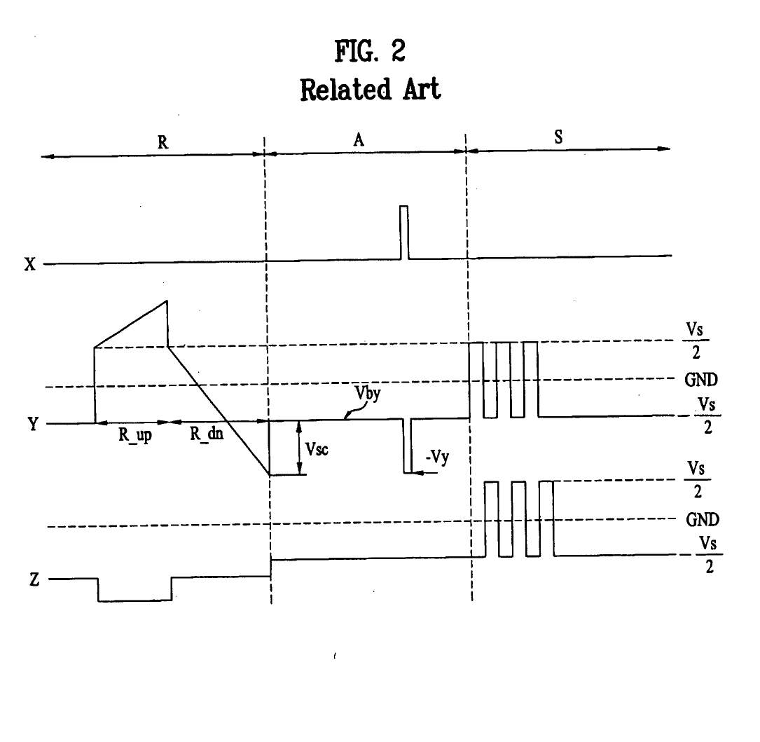

### DETAILED DESCRIPTION OF THE INVENTION

Reference will now be made in detail to the preferred embodiments of the present invention associated with a drying apparatus, examples of which are illustrated in the accompanying drawings. Wherever possible, the same reference numbers will be used throughout the drawings to refer to the same or like parts.

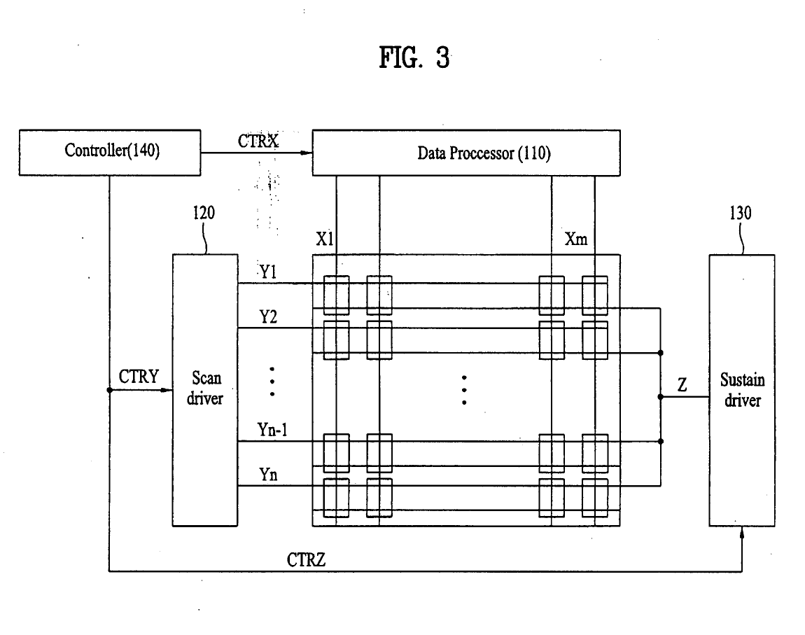

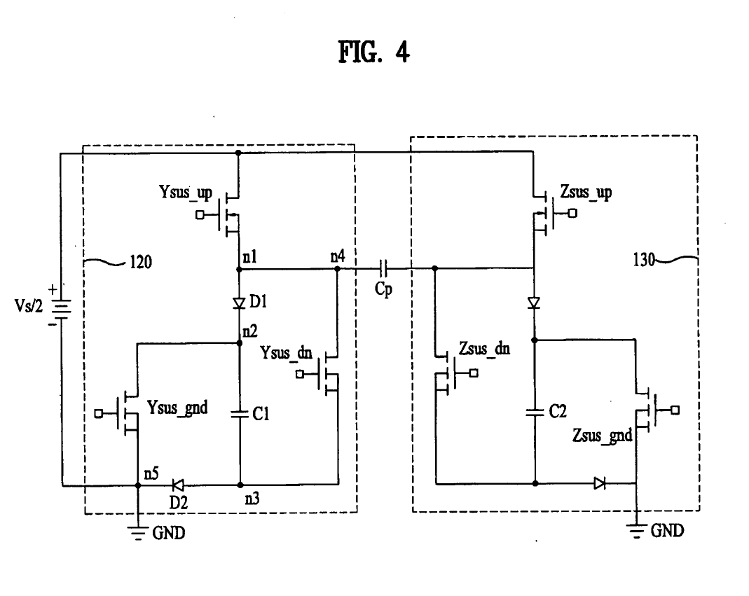

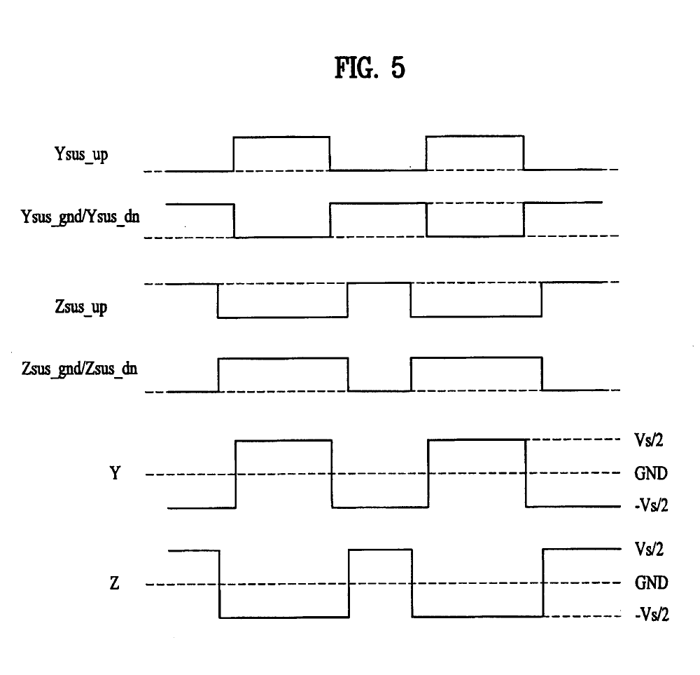

FIG. 3 is a block diagram for explaining a method for driving a plasma display panel in accordance with the present invention. FIG. 4 is a circuit diagram illustrating an apparatus for driving a plasma display panel in accordance with a first embodiment of the present invention. FIG. 5 is a timing diagram illustrating ON/OFF timings of switches shown in FIG. 4.

Referring to FIG. 3, a plasma display panel, to which the present invention is applied, is shown. As shown in FIG. 3, the plasma display panel includes a plurality of address electrodes X arranged in columns, a plurality of scan electrodes Y arranged in rows, and a plurality of sustain electrodes Z arranged in rows. The scan electrodes Y correspond to the sustain electrodes Z, respectively. The sustain electrodes Z are connected together at one-side ends thereof such that they receive the same voltage.

The plasma display panel is manufactured by bonding a front panel on which the scan electrodes Y and sustain electrodes Z are formed to extend in parallel, and a back panel on which the address electrodes X are formed. The scan electrodes Y and sustain electrodes Z perpendicularly cross the address electrodes X while facing the address electrodes X at opposite sides of discharge spaces. Each discharge space is defined in a region where one scan electrode Y and one sustain electrode Z associated with the scan electrode Y cross one address electrode X. Each discharge space forms a unit discharge cell.

Referring to FIG. 3, an apparatus for driving the plasma display panel in accordance with the present invention is also illustrated. As shown in FIG. 3, the plasma display panel (PDP) driving apparatus includes a data processor or data driver 110 for applying data to the address electrodes X, namely, X1 to Xm, a scan driver 120 for driving the scan electrodes Y, namely, Y1 to Yn, a sustain driver 130 for driving the sustain electrodes Z, and a controller 140 for controlling the drivers 110 to 130.

The data processor or data driver 110 samples input data in response to a timing control signal from the controller 140, latches the sampled data, and subsequently supplies the latched data to the address electrodes X1 to Xm (hereinafter, simply referred to as “address electrodes X”).

The scan driver 120 supplies scan pulses and sustain pulses to the scan electrodes Y1 to Yn (hereinafter, simply referred to as “scan electrodes Y”) under the control of the controller 140. The sustain driver 130 supplies sustain pulses to the sustain electrodes Z under the control of the controller 140. The sustain driver 130 operates alternately with the scan driver 120.

The controller 140 receives a vertical/horizontal synchronous signal and a clock signal, thereby generating timing control signals CTRX, CTRY, and CTRZ required in the drivers 110 to 130. The controller 140 supplies the generated timing control signals CTRX, CTRY, and CTRZ to the associated drivers 110 to 130, to control the drivers 110 to 130, respectively.

The plasma display panel may be driven in accordance a half sustain driving scheme. In the half sustain driving scheme, the scan driver 120 or sustain driver 130 generates a sustain pulse switched between a negative voltage level corresponding to half of a sustain voltage Vs, namely, −Vs/2, and a positive voltage level corresponding to half of the sustain voltage Vs, Vs/2.

Conventionally, a sustain pulse is used which swings fully between the ground voltage level GND and the sustain voltage Vs. In accordance with the half sustain driving scheme, however, the sustain pulse has a maximum voltage level corresponding to half of the sustain voltage Vs, namely, Vs/2, and a minimum voltage level corresponding to a level lower than the ground voltage level GND by half of the sustain voltage Vs.

When the above-described half sustain driving scheme is used, it is possible to reduce the intensity of an electric field formed between the scan electrode Y and the address electrode X or between the sustain electrode Z and the address electrode X during a discharge carried out between the scan electrode Y and the sustain electrode Z, while equalizing the amounts of wall charge respectively created at the scan electrode Y and the sustain electrode Z for sustain discharge.

When the intensity of the electric field formed between the scan electrode Y and the address electrode X or between the sustain electrode Z and the address electrode X during a sustain discharge is increased, the sustain discharge generated between the scan electrode Y and the sustain electrode Z may be weakened. Using the above-described half sustain driving scheme, however, it is possible to more stably drive the plasma display panel.

For the maximum and minimum voltage levels of the sustain pulse, voltage components having the same level, but having opposite polarities, for example, Vs/2 and −Vs/2, are used. Accordingly, it is possible to configure a circuit for applying the above-described sustain pulse, using a signal voltage source.

In this regard, as shown in FIG. 4, the scan driver 120 includes a first switch Ysus_up for performing a switching operation to apply a voltage from a voltage source Vs/2 to a panel Cp, a first capacitor C1 charged with the voltage in accordance with the switching operation of the first switch Ysus_up, and second and third switches Ysus_dn and Ysus_gnd for performing switching operations reverse to the switching operation of the first switch Ysus_up, to discharge the voltage from the panel Cp and the voltage from the first capacitor C1, respectively.

The first switch Ysus_up is electrically connected between the voltage source Vs/2 and the panel Cp. The second switch Ysus_dn is electrically connected between a fourth node n4, between the first switch Ysus_up and the panel Cp, and a ground source. The first capacitor C1 is electrically connected between a third node n3, between the second switch Ysus_dn and the ground source, and a first node n1, between the first switch Ysus_up and the panel Cp. The third switch Ysus_gnd is electrically connected between a second node n2, between the first switch Ysus_up and the first capacitor C1, and a fifth node n5, between the second switch Ysus_dn and the ground source.

A first diode D1 is electrically connected between the first node n1 and the second node n2. A second diode D2 is electrically connected between the third node n3 and the fifth node n5.

Hereinafter, operation of the PDP driving apparatus according to the first embodiment of the present invention will be described.

When the first switch Ysus_up conducts, the positive sustain voltage component Vs/2 is applied from the external source thereof to the panel Cp via the first switch Ysus_up. As a result, the first capacitor C1 is charged with a voltage to a level corresponding to the sustain voltage component Vs/2.

Accordingly, the voltage output from the scan electrode Y has a waveform increasing from a minimum sustain voltage level of −Vs/2, which is negative, to a maximum sustain voltage level of Vs/2, which is positive.

After a predetermined time elapses, the first switch Ysus_up is turned off. When the second and third switches Ysus_dn and Ysus_gnd conduct under this condition, current is discharged out of the panel Cp, thereby causing the voltage applied to the scan electrode Y to be reduced from the maximum sustain voltage level of Vs/2 to the negative, minimum sustain voltage level of −Vs/2.

That is, when the third switch Ysus_gnd conducts, the voltage at one end n2 of the first capacitor C1 connected to the third switch Ysus_gnd is reduced to the negative, minimum sustain voltage level of −Vs/2 because the first capacitor C1 has a ground voltage level at the other end n3 thereof. As a result, the sustain voltage applied to the scan electrode Y has the negative, minimum voltage level of −Vs/2.

In accordance with the conduction states of the second and third switches Ysus_dn and Ysus_gnd, the current discharged from the first capacitor C1 flows to the first switch Ysus_up.

That is, since the voltage at the node n1 between the first switch Ysus_up and the panel Cp is higher than that of the first capacitor C1, current flows from the first capacitor C1 to the first switch Ysus_up when the second and third switches Ysus_dn and Ysus_gnd conduct. As a result, the voltage applied to the sustain electrode Y cannot be lowered to the negative, minimum sustain voltage level of −Vs/2.

In order to prevent this phenomenon, a backflow prevention element is connected between the first switch Ysus_up and the first capacitor C1. The backflow prevention element functions to prevent the current discharged from the capacitor in accordance with the conduction of the second and third switches Ysus_dn and Ysus_gnd from flowing backward to the first switch Ysus_up.

The backward flow prevention element may be implemented using a switch such as an FET or a diode. In this specification, an embodiment, in which the backward flow prevention element is implemented using a diode, is described. However, it will be appreciated that the kind of the backward flow prevention element is not limited to that described in the specification.

Where a diode D1 (hereinafter, referred to as a “first diode”) is used as the backward flow prevention element, the diode D1 is connected, at an anode thereof, to the first switch Ysus_up (n1), and is connected, at a cathode thereof, to the other end n3 of the first capacitor C1.

Also, when current is discharged from the first capacitor C1 as the second and third switches Ysus_dn and Ysus_gnd conduct, in order to apply the negative sustain voltage component of −Vs/2 to the scan electrode Y, the current directed to the ground source GND may flow backward.

In this case, the current path extending from the panel Cp to the third switch Ysus_gnd via the second switch Ysus_dn and the first capacitor C1 cannot be normally established. As a result, a normal sustain pulse cannot be applied to the scan electrode Y.

In order to prevent this phenomenon, a backflow prevention element is connected between the second switch Ysus_dn and the third switch Ysus_gnd. The backflow prevention element functions to prevent the current directed to the ground source GND from flowing backward to the first capacitor C1.

Where a diode D2 (hereinafter, referred to as a “second diode”) is used as the backward flow prevention element, the diode D2 is connected, at an anode thereof, to one end n2 of the first capacitor C1, and is connected, at a cathode thereof, to a source terminal of the third switch Ysus_gnd.

In this case, the voltage stress of the first switch Ysus_up corresponds to Vs, whereas the voltage stress of the second and third switches Ysus_dn and Ysus_gnd corresponds to half of the voltage stress applied to the first switch Ysus_up (Vs/2).

Accordingly, when the circuit for applying sustain pulses is configured as described above, it is possible to not only enable the application of positive and negative sustain voltage components Vs/2 and −Vs/2 using a single voltage source, and but also to reduce the number of switches used to constitute the circuit.

Although 5 or more switches are used for application of positive and negative sustain voltage components Vs/2 and −Vs/2 in conventional cases, sustain pulses can be generated using 3 switches in accordance with the present invention.

It is also possible to achieve an enhancement in the stability of the circuit because the voltage stress applied to the switches is not high in spite of the reduced number of the switches. In addition, the circuit can be configured using switches requiring an internal voltage that is not high. Accordingly, it is possible to reduce the costs required to configure the circuit.

The sustain driver 130 for applying sustain pulses to the sustain electrodes Z has the same configuration as the scan driver 120, as shown in FIG. 4.

That is, the sustain driver 130 includes a fourth switch Zsus_up for performing a switching operation to apply an external positive voltage Vs/2 to the panel Cp, a second capacitor C2 charged with current as the fourth switch Zsus_up conducts, and fifth and sixth switches Zsus_dn and Zsus_gnd operating complementarily with the fourth switch Zsus_up, to discharge current from the panel Cp and the second capacitor C2 when they conduct, respectively.

The fourth to sixth switches Zsus_up, Zsus_dn, and Zsus_gnd included in the sustain driver 130 operate reversely to the first to third switches Ysus_up, Ysus_dn, and Ysus_gnd.

Referring to FIG. 5, a negative sustain pulse of −Vs/2 should be applied to the sustain electrode Z when a positive sustain pulse of Vs/2 is applied to the scan electrode Y. Accordingly, the fourth to sixth switches Zsus_up, Zsus_dn, and Zsus_gnd must operate reversely to the first to third switches Ysus_up, Ysus_dn, and Ysus_gnd.

Under the condition in which the first switch Ysus_up is turned on, and the second and third switches Ysus_dn and Ysus_gnd are turned off, a positive sustain pulse of Vs/2 is applied to the scan electrode Y.

Conversely, under the condition in which the fourth switch Zsus_up is turned off, and the fifth and sixth switches Zsus_dn and Zsus_gnd are turned on, a negative sustain pulse of −Vs/2 is applied to the sustain electrode Z.

When the first switch Ysus_up is subsequently turned off, and the second and third switches Ysus_dn and Ysus_gnd are turned on, a negative sustain pulse of −Vs/2 is applied to the scan electrode Y. On the other hand, when the fourth switch Zsus_up is turned on, and the fifth and sixth switches Zsus_dn and Zsus_gnd are turned off, a positive sustain pulse of Vs/2 is applied to the sustain electrode Z.

Thus, it is possible to apply sustain pulses to the scan electrode Y and the sustain electrode Z by controlling ON/OFF timings of the first to third switches Ysus_up, Ysus_dn, and Ysus_gnd and the fourth to sixth switches Zsus_up, Zsus_dn, and Zsus_gnd.

The ON/OFF timings of the switches Ysus_up, Ysus_dn, Ysus_gnd, Zsus_up, Zsus_dn, and Zsus_gnd, and the waveforms of the sustain pulses applied to the scan electrode Y and sustain electrode Z are depicted in FIG. 5.

When the number of switches constituting the scan driver 120 and sustain driver 130 is reduced, as described above, it is possible to reduce the loss of the waveforms applied to the scan electrode Y and sustain electrode Z.

When the number of switches existing in a current path from the external voltage source Vs/2 to the panel Cp or in a current path from the panel Cp to the ground source GND is increased, a correspondingly increased voltage drop occurs, thereby causing loss of current.

In accordance with the present invention, the number of switches used to constitute the scan driver 120 and sustain driver 130 is reduced to half of the number of switches used in conventional cases. Accordingly, the amount of current loss generated when current passes through the switches is reduced. As a result, it is possible to reduce distortion of waveforms, and thus, to achieve stable application of sustain pulses. By virtue of the reduced current loss, the efficiency of the circuit is also enhanced.

In addition, the switch driver for controlling ON/OFF of the switches can be simplified. Accordingly, it is possible to reduce the costs required to configure the switch driver and the number of circuits used to constitute the switch drive, and thus, to achieve an enhancement in circuit reliability.

An energy recoverer ER may be provided in the scan driver 120, in order to recover reactive current during application of a sustain pulse, and to use the recovered current upon application of a next sustain pulse, and thus, to reduce power consumption.

In the following description, an example, in which the energy recoverer ER is connected to the scan driver 120, will be described. However, another energy recoverer is also connected to the sustain driver 130, similarly to the scan driver 120.

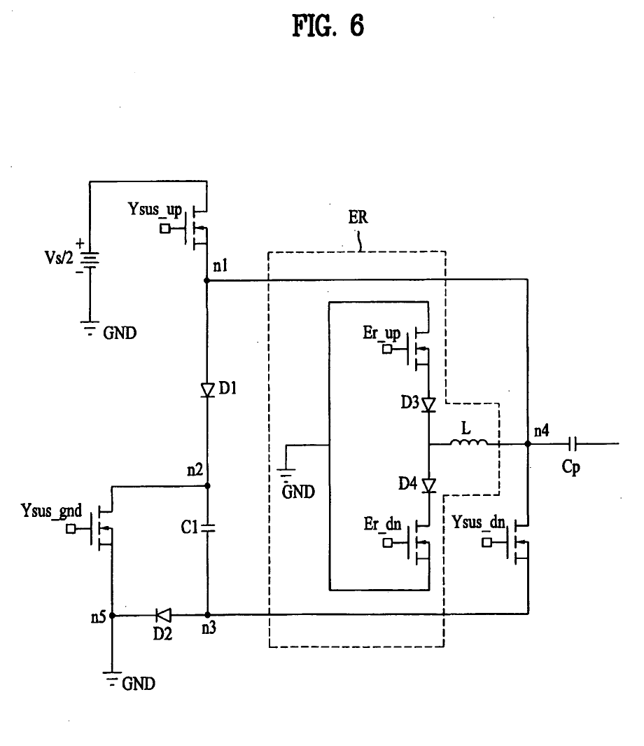

FIG. 6 is a circuit diagram illustrating an apparatus for driving a plasma display panel in accordance with a second embodiment of the present invention. As shown in FIG. 6, the above-described energy recoverer ER is connected between the first switch Ysus_up and the second switch Ysus_dn (n1).

The energy recoverer ER includes an inductor L for generating resonance current, and one or more energy recovery switches connected to the inductor L, to recover reactive current from the panel Cp. In the illustrated case, two energy recovery switches Er_up and Er_dn are shown.

The energy recovery switch Er_up (hereinafter, referred to as a “first recovery switch”) functions to recover energy stored in the panel Cp. The energy recovery switch Er_dn (hereinafter, referred to as a “second recovery switch”) functions to apply the recovered energy to the panel Cp.

Diodes D3 and D4 are connected to the first and second recovery switches Er_up and Er_down, respectively, to prevent backward flow of resonance current.

When it is desired to apply a positive sustain voltage component of Vs/2 to the scan electrode Y, the first recovery switch Er_up is turned on before turn-on of the first switch Ysus_up, in order to resonate a recovered voltage, and thus, to apply the resonated voltage to the scan electrode Y.

When the first recovery switch Er_up is turned on, the voltage level of the scan electrode Y is increased from a level corresponding to the low sustain voltage level of −Vs/2 to a level near the high sustain voltage level of Vs/2. When the first switch Ysus_up is subsequently turned on, the voltage level of the scan electrode Y is increased to the high sustain voltage level of Vs/2.

On the other hand, the second recovery switch Er_dn is turned on before the second and third switches Ysus_dn and Ysus_gnd are turned on, to recover the voltage applied to the scan electrode Y, and thus, to enable the recovered voltage upon application of the next sustain pulse.

Where the scan driver 120 is provided with the energy recoverer ER, as described above, it is possible to recover the reactive current of the panel Cp, and thus, to use the recovered current upon application of a sustain pulse. Accordingly, a reduction in power consumption can be achieved.

Hereinafter, a method for driving a plasma display device using the PDP driving apparatus having the above-described configuration according to the present invention will be described.

The driving method includes turning on the first switch Ysus_up and turning off the second and third switches Ysus_dn and Ysus_gnd, to generate a sustain pulse having a maximum voltage level of Vs/2, and turning off the first switch Ysus_up and turning on the second and third switches Ysus_dn and Ysus_gnd, to discharge current from the panel, and thus, to generate a sustain pulse having a minimum voltage level of −Vs/2.

In accordance with this driving method, the first recovery switch Er_up is first turned on, in order to enable a sustain pulse having a voltage level increasing from the negative, minimum sustain voltage level of −Vs/2 to the positive, maximum sustain voltage level of Vs/2 to be applied to the scan electrode Y.

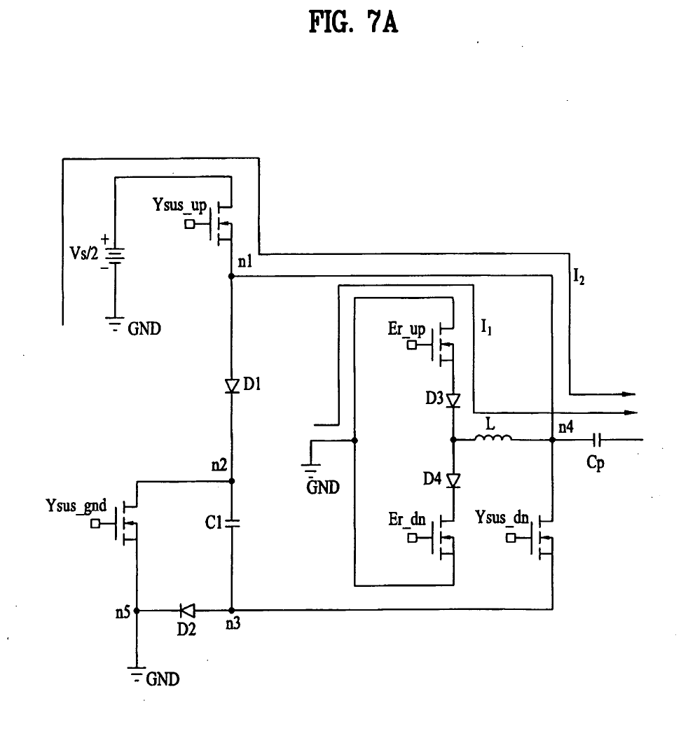

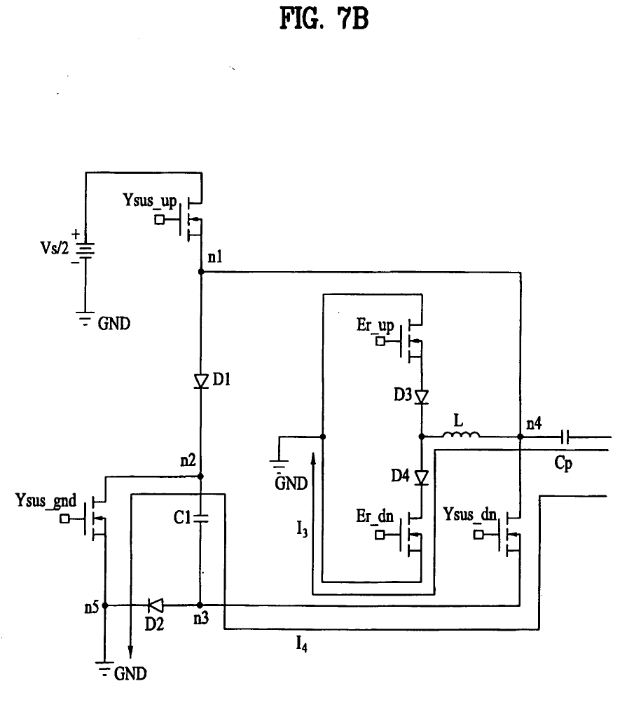

When the first recovery switch Er_up conducts, resonance current is generated between the first recovery switch Er_up and the inductor L, as shown in FIG. 7A. The resonance current is then applied to the panel Cp (I₁).

When the first switch Ysus_up is subsequently turned on, current I₂ flows from the external voltage source Vs/2 to the panel Cp via the first switch Ysus_up. As a result, a positive, maximum sustain voltage component of Vs/2 is applied to the scan electrode Y.

After a predetermined time elapses, the second recovery switch Er_dn is turned on, in order to enable a sustain pulse having a voltage level decreasing from the level of the positive, maximum sustain voltage component of Vs/2 to the level of the negative, minimum sustain voltage component of −Vs/2 to be applied to the scan electrode Y.

When the second recovery switch Er_dn is turned on, reactive current is recovered from the panel Cp via the inductor L (I₃), as shown in FIG. 7B. The recovery of reactive current can be carried out by simply connecting the second recovery switch Er_dn to the ground source GND without using a separate capacitor. This is because the intermediate level of the sustain pulse between-the maximum sustain voltage level of Vs/2 and the minimum sustain voltage level of −Vs/2 is the ground level.

When the second and third switches Ysus_dn and Ysus_gnd are subsequently turned on, current flows from the panel Cp to the ground source GND (I₄). Accordingly, the negative, minimum sustain voltage component of −Vs/2 is applied to the scan electrode Y.

When application of sustain pulses is carried out using the first to third switches Ysus_up, Ysus_dn, and Ysus_gnd, as described above, it is possible to achieve the application of sustain pulses in a half sustain driving scheme using a signal voltage source, with a reduced number of switches.

The reduced number of switches simplifies the ON/OFF control for the switches, reduces distortion of applied sustain pulses, and enables stable application of sustain pulses. Accordingly, an enhancement in reliability is achieved.

The voltage stress applied to the switches is similar to those of conventional cases. Accordingly, it is possible to configure a desired circuit using a reduced number of switches without a considerable increase in voltage stress. As a result, the manufacturing costs are reduced. Also, the efficiency of the circuit is enhanced.

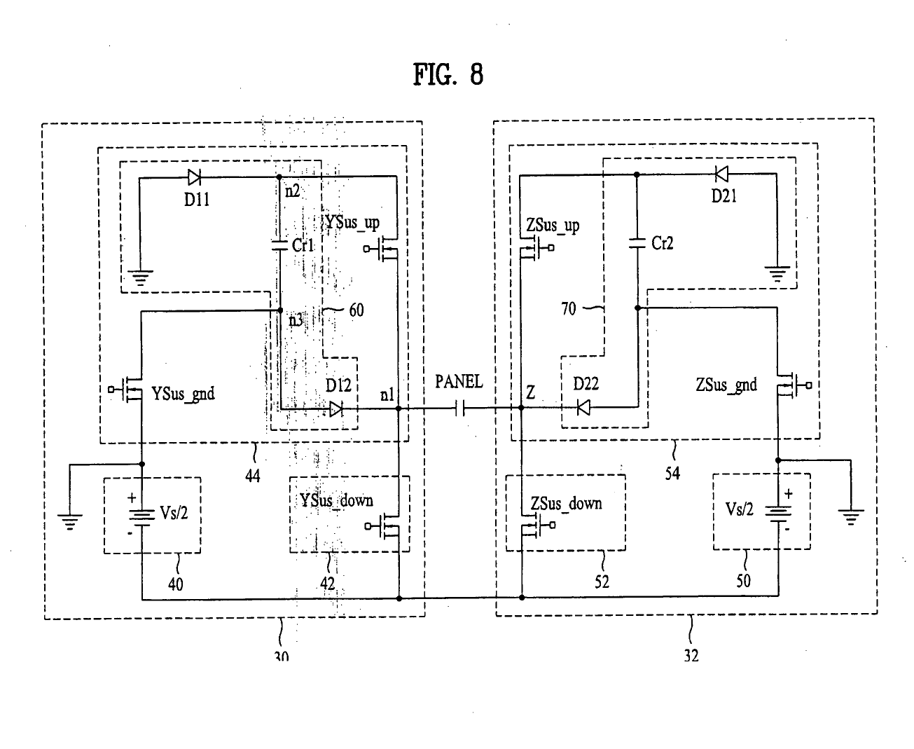

FIG. 8 is a circuit diagram illustrating an apparatus for driving a plasma display panel in accordance with a third embodiment of the present invention.

The PDP driving apparatus according to the third embodiment of the present invention may include a voltage source Vs/2, a first switch YSus_down, a capacitor Cr1, a second switch YSus_up, and a third switch YSus_gnd, as shown in FIG. 8.

The first switch YSus_down performs a switching operation to apply a negative voltage from the voltage source Vs/2 to a panel PANEL. The capacitor Cr1 is charged with a positive voltage in accordance with the switching operation of the first switch YSus_down. The second and third switches YSus_up and YSus_gnd perform switching operations reverse to the switching operation of the first switch YSus_down, to apply the voltage of the capacitor Cr1 to the panel PANEL.

The first switch YSus_down is electrically connected between the panel PANEL and the voltage source Vs/2. The second switch YSus_up is electrically connected between a first node n1, between the panel PANEL and the first switch YSus_down, and a first ground source.

The capacitor Cr1 is electrically connected between a second node n2, between the second switch YSus_up and the first ground source, and the first node n1. The third switch YSus_gnd is electrically connected between a third node n3, between the capacitor Cr1 and the first node 1, and a second ground source.

The capacitor Cr1 and the second switch YSus_up are connected in parallel. A first diode D11 is electrically connected between the first ground source and the second node n2. A second diode D12 is electrically connected between the first node n1 and the third node n3.

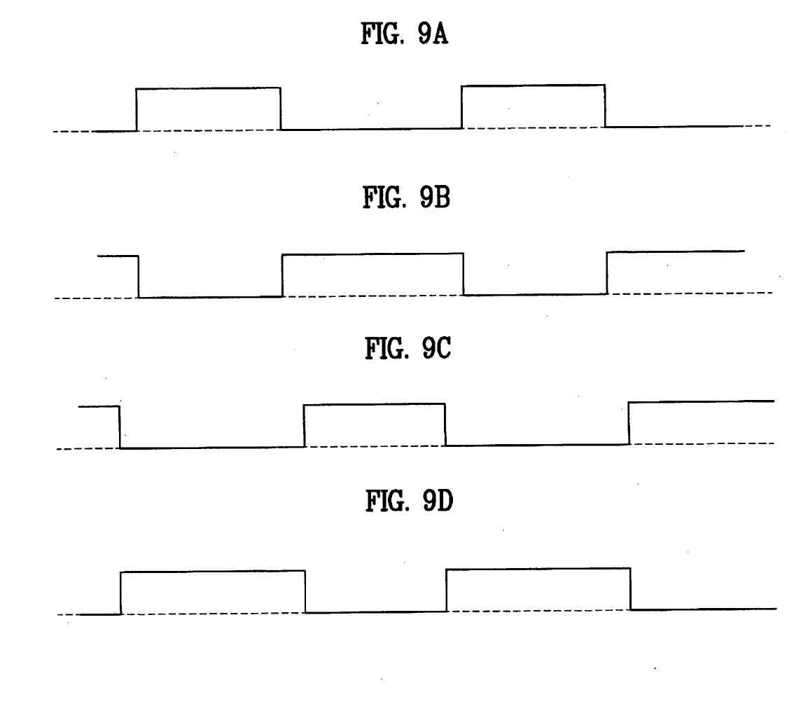

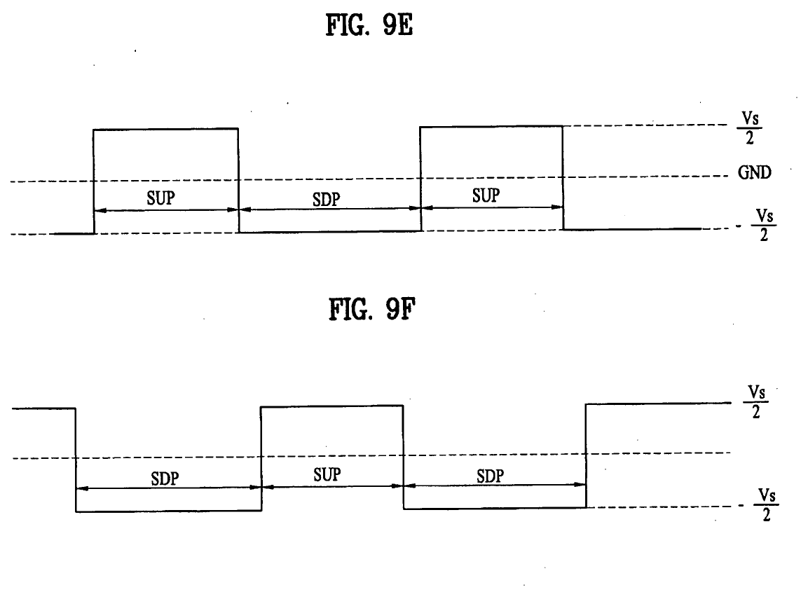

FIGS. 9A to 9F are waveform diagrams of drive signals associated with constituent elements shown in FIG. 8. FIG. 9A shows a drive signal applied to each gate of the second and third switches YSus_up and YSus_gnd. FIG. 9B shows a drive signal applied to the gate of the first switch YSus_down. FIG. 9C shows a drive signal applied to each of second and third switches ZSus_up and ZSus_gnd. FIG. 9D shows a drive signal applied to the gate of a first switch ZSus_down. FIG. 9E is a waveform diagram of a sustain pulse supplied to the scan electrode Y. FIG. 9F is a waveform diagram of a sustain pulse supplied to the sustain electrode Z.

Referring to FIG. 8, the PDP driving apparatus according to the third embodiment of the present invention includes a first sustain pulse supplier 30. The voltage source Vs/2, first switch YSus_down, capacitor Cr1, second switch YSus_up, and third switch YSus_gnd are included in the first sustain pulse supplier 30. The first sustain pulse supplier 30 functions to supply a negative sustain voltage to the scan electrode Y for a sustain-down period SDP shown in FIG. 9E, and to supply a positive sustain voltage to the sustain electrode Z for a sustain-up period SUP shown in FIG. 9E.

The PDP driving apparatus also includes a second sustain pulse supplier 32 which, similarly to the first sustain pulse supplier 30, functions to supply a negative sustain voltage to the scan electrode Y for a sustain-down period SDP shown in FIG. 9F, and to supply a positive sustain voltage to the sustain electrode Z for a sustain-up period SUP shown in FIG. 9F.

For example, when a single voltage source of Vs/2 is used, as shown in FIG. 8, the PDP driving apparatus according to the third embodiment of the present invention alternately outputs a negative sustain voltage component of −Vs/2 and a positive sustain voltage component of Vs/2 in a half sustain mode.

Hereinafter, the configuration and operation of the PDP driving apparatus according to the third embodiment of the present invention will be described in detail with reference to FIG. 8 and FIGS. 9A to 9F.

The first sustain pulse supplier 30 includes a sustain voltage source 40, a negative sustain voltage supplier 42, and a positive sustain voltage supplier 44. In this case, the sustain voltage source 40 is the voltage source Vs/2 which supplies a sustain voltage component of Vs/2.

The negative sustain voltage supplier 42 is connected to a negative terminal of the sustain voltage source 40, to supply a negative sustain voltage component of −Vs/2 to the panel PANEL for a sustain-down period SDP. To this end, in accordance with the illustrated embodiment of the present invention, the negative sustain voltage supplier 42 may be implemented by the switch YSus_down which is connected between the negative terminal of the sustain voltage source 40 and the panel PANEL, and is turned on for a sustain-down period SDP, to supply a negative sustain voltage component of −Vs/2 to the panel PANEL.

The positive sustain voltage supplier 44 is connected to the negative terminal of the sustain voltage source 40 via the negative sustain voltage supplier 42 for a sustain-down period SDP, to be charged with a positive sustain voltage component of Vs/2, and to supply the charged positive sustain voltage component of Vs/2 to the panel PANEL for a sustain-up period SUP. To this end, in accordance with the illustrated embodiment of the present invention, the positive sustain voltage supplier 44 may be implemented by a charger 60 together with the switches YSus_up and YSus_gnd.

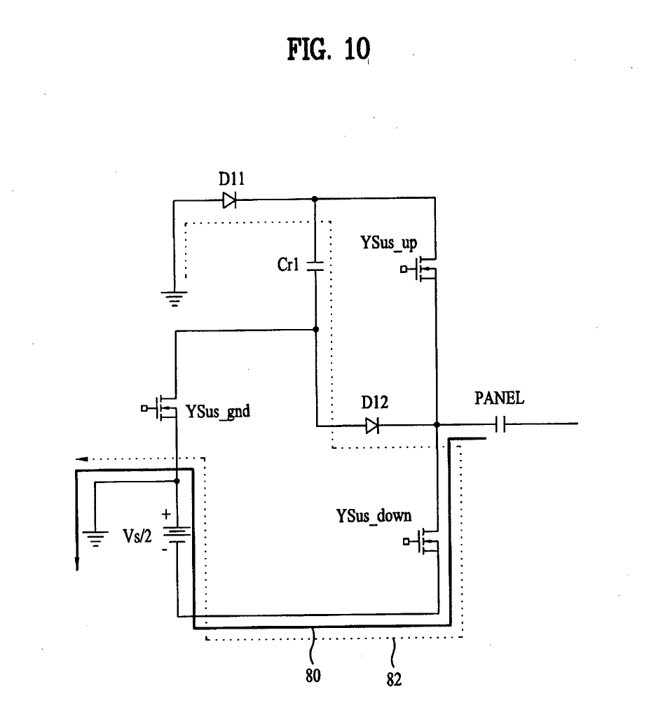

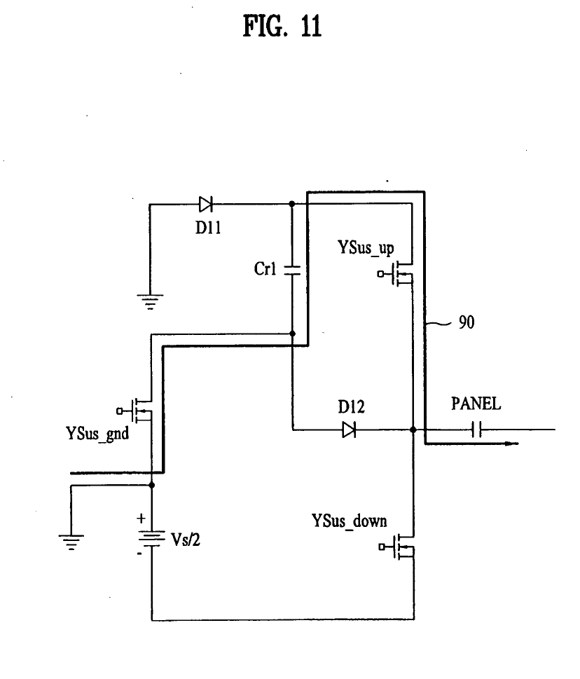

FIG. 10 is a circuit diagram for explaining operation of the first sustain pulse supplier 30 shown in FIG. 8 in a sustain-down period SDP shown in FIG. 9E.

The charger 60 has a function to be charged with a positive sustain voltage component of Vs/2 for the sustain-down period SDP shown in FIG. 9E. To this end, the switch YSus_down is turned on in response to a drive signal having an up-level of Vs/2, as shown in FIG. 9B, in the sustain-down period SDP shown in FIG. 9E. Also, the switches YSus_up and YSus_gnd are turned off in response to a drive signal having a down-level of −Vs/2 as shown in FIG. 9A. In this state, current is sunk from the panel PANEL in an arrow direction 80, as shown in FIG. 10, so that a negative sustain voltage as shown in FIG. 9E is supplied to the panel PANEL. In the sustain-down period SDP, for which the negative sustain voltage as shown in FIG. 9E is supplied, the charger 60 is coupled to the negative sustain voltage via the switch YSus_down, so that it is charged to a voltage level of Vs/2. To this end, the charger 60 may be implemented by the capacitor Cr1, and the diodes D11 and D12. As described above, the capacitor Cr1 is arranged between the switches Ysus_up and YSus_gnd, and is charged with a positive sustain voltage component of Vs/2. The diode D11 has a cathode connected to the node n2 (FIG. 8) between the capacitor Cr1 and the switch YSus_up, and an anode connected to a ground source. The diode D12 has an anode connected to the node n3 (FIG. 8) between the capacitor Cr1 and the switch YSus_gnd, and a cathode connected to the panel PANEL. In accordance with the above-described configuration of the charger 60, a current path is established which extends from the ground source to the negative sustain voltage via the capacitor Cr1 and the switch YSus_down in an arrow direction 82 in FIG. 10. Accordingly, a voltage of Vs/2 can be charged in the capacitor Cr1.

FIG. 11 is a circuit diagram for explaining operation of the first sustain pulse supplier 30 shown in FIG. 8 in a sustain-up period SDP shown in FIG. 9E.

For a sustain-up period SUP shown in FIG. 9E, the charger 60 discharges the positive sustain voltage charged in the sustain-down period SDP shown in FIG. 9E. To this end, the switch YSus_down is turned off in response to a drive signal having a down-level of −Vs/2, as shown in FIG. 9B. Also, the switches YSus_up and YSus_gnd are turned on in response to a drive signal having an up-level of Vs/2 as shown in FIG. 9A. In this state, a current path is established which extends from the ground source to the panel PANEL via the switch YSus_gnd, capacitor Cr1 and switch YSus_up in an arrow direction 90 in FIG. 11. Accordingly, a positive sustain voltage as shown in FIG. 9E can be supplied to the scan electrode Y for the sustain-up period SUP. Thus, the switch YSus_up, which is connected between the charger 60 and the panel PANEL, is turned on for the sustain-up period SUP as shown in FIG. 9E, to supply the positive sustain voltage discharged from the charger 60 to the panel PANEL. On the other hand, the switch YSus_gnd, which is connected between the ground source and the charger 60, is turned on for the sustain-up period SUP as shown in FIG. 9E, to establish a path for discharging the positive sustain voltage to the panel PANEL.

Meanwhile, the second sustain pulse supplier 32 shown in FIG. 8 operates as follows.

The second sustain pulse supplier 32 includes a sustain voltage source 50, a negative sustain voltage supplier 52, and a positive sustain voltage supplier 54. The sustain voltage source 50 supplies a sustain voltage component of Vs/2.

The negative sustain voltage supplier 52 is connected to a negative terminal of the sustain voltage source 50, to supply a negative sustain voltage component of −Vs/2 to the panel PANEL for a sustain-down period SDP. To this end, in accordance with the illustrated embodiment of the present invention, the negative sustain voltage supplier 52 may be implemented by a switch ZSus_down which is connected between the negative terminal of the sustain voltage source 50 and the panel PANEL, and is turned on for a sustain-down period SDP, to supply a negative sustain voltage to the panel PANEL.

The positive sustain voltage supplier 54 is connected to the negative terminal of the sustain voltage source 50 via the negative sustain voltage supplier 52 for a sustain-down period SDP, to be charged with a positive sustain voltage component of Vs/2, and to supply the charged positive sustain voltage component of Vs/2 to the panel PANEL for a sustain-up period SUP. To this end, in accordance with the illustrated embodiment of the present invention, the positive sustain voltage supplier 54 may be implemented by a charger 70, and switches ZSus_up and ZSus_gnd.

The charger 70 has a function to be charged with a positive sustain voltage component of Vs/2 for the sustain-down period SDP. To this end, the switch ZSus_down is turned on in response to a drive signal having an up-level of Vs/2 in the sustain-down period SDP. Also, the switches ZSus_up and ZSus_gnd are turned off in response to a drive signal having a down-level of −Vs/2. In the sustain-down period SDP, for which the negative sustain voltage is supplied, the charger 70 is coupled to the negative sustain voltage via the switch ZSus_down. As a result, a voltage of Vs/2 can be charged in a capacitor Cr2. To this end, the charger 70 may be implemented by diodes D21 and D22 together with the capacitor Cr2. The capacitor Cr2 is arranged between the switches Zsus_up and ZSus_gnd, and is charged with a positive sustain voltage component of Vs/2. The diode D21 has a cathode connected to a node between the capacitor Cr2 and the switch ZSus_up, and an anode connected to a ground source. The diode D22 has an anode connected to a node between the capacitor Cr2 and the switch ZSus_gnd, and a cathode connected to the panel PANEL.

For the sustain-up period SUP, the charger 70 discharges the positive sustain voltage charged in the sustain-down period SDP. To this end, the switch ZSus_down is turned off in response to a drive signal having a down-level of −Vs/2. Also, the switches ZSus_up and ZSus_gnd are turned on in response to a drive signal having an up-level of Vs/2. In this state, a positive sustain voltage can be supplied to the sustain electrode Z for the sustain-up period SUP. Thus, the switch ZSus_up, which is connected between the charger 70 and the panel PANEL, is turned on for the sustain-up period SUP, to supply the positive sustain voltage discharged from the charger 70 to the panel PANEL. On the other hand, the switch ZSus_gnd, which is connected between the ground source and the charger 70, is turned on for the sustain-up period SUP, to establish a path for discharging the positive sustain voltage to the panel PANEL.

In FIG. 8, the voltage stress applied to the switches YSus_up, YSus_gnd, ZSus_up, and ZSus_gnd is Vs/2. Similarly, the voltage stress applied to the switches YSus_down, ZSus_down is Vs/2.

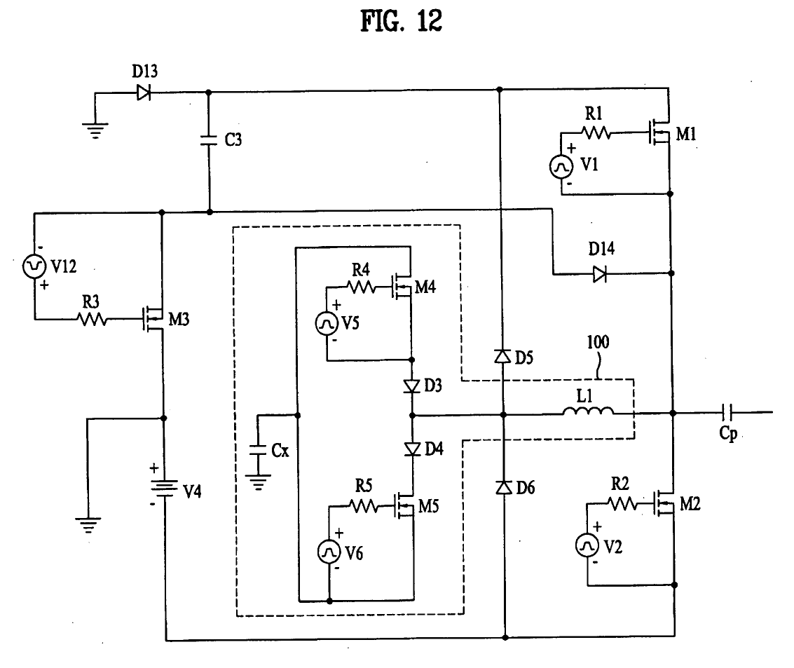

FIG. 12 is a circuit diagram illustrating an apparatus for driving a plasma display panel in accordance with a fourth embodiment of the present invention.

The PDP driving apparatus shown in FIG. 12 includes an energy recoverer 100, in addition to the configuration of the PDP driving apparatus shown in FIG. 8. In FIG. 12, accordingly, a voltage source V4 corresponds to the voltage source Vs/2 of FIG. 8, a switch M2 corresponds to the switch YSus_down or ZSus_down of FIG. 8, a switch M1 corresponds to the switch YSus_up or ZSus_up of FIG. 8, a switch M3 corresponds to the switch YSus_gnd or ZSus_gnd, a diode D13 corresponds to the diode D11 or D21 of FIG. 8, a diode D14 corresponds to the diode D12 or D22 of FIG. 8, and a capacitor C3 corresponds to the capacitor Cr1 or Cr2.

The energy recoverer 100 recovers the positive sustain voltage supplied to the panel for a sustain-up period, and supplies the recovered voltage to the panel before the next sustain-up period is begun. To this end, the energy recoverer 100 may be implement by an external capacitor Cx, an inductor L1, switches M4 and M5, and diodes D3 and D4.

The external capacitor Cx shown in FIG. 12 functions to be charged with the recovered voltage. The inductor L1 is connected, at one end thereof, to the panel. The switches M4 and M5 are connected in parallel between the other end of the inductor L1 and the external capacitor Cx. The diodes D3 and D4 are connected in series between the switches M4 and M5, to suppress backward flow of current.

In FIG. 12, each of the switch Ml to M5 is connected with an associated one of gate resistors R1 to R5 and an associated one of drive voltage sources V1, V2, V12, V5, and V6.

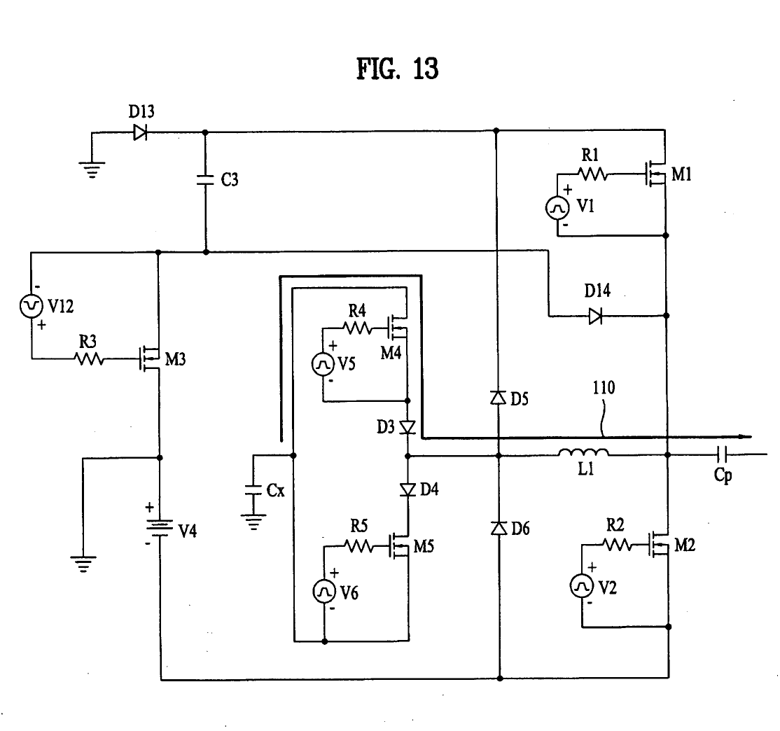

FIGS. 13 to 16 are circuit diagrams for explaining operation of the PDP driving apparatus shown in FIG. 12.

First, the PDP driving apparatus shown in FIG. 12 again supplies a recovered voltage to the panel. To this end, a current path is established which extends from a ground source to a panel capacitor Cp via the external capacitor Cx, diode D3, and inductor L1 in an arrow direction 110 shown in FIG. 13. The panel capacitor Cp equivalently represents the capacitance of the panel.

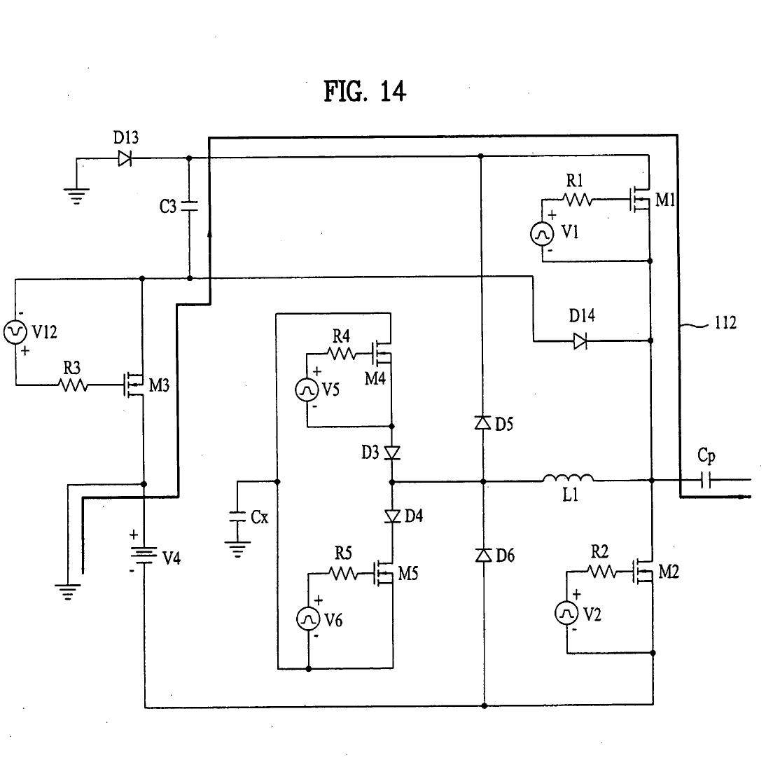

Thereafter, the PDP driving apparatus of FIG. 12 supplies a positive sustain voltage to the panel. In this state, a current path is established which extends from the ground source to the panel capacitor Cp via the switch M3, capacitor C3, and switch M1 in an arrow direction 112 shown in FIG. 14.

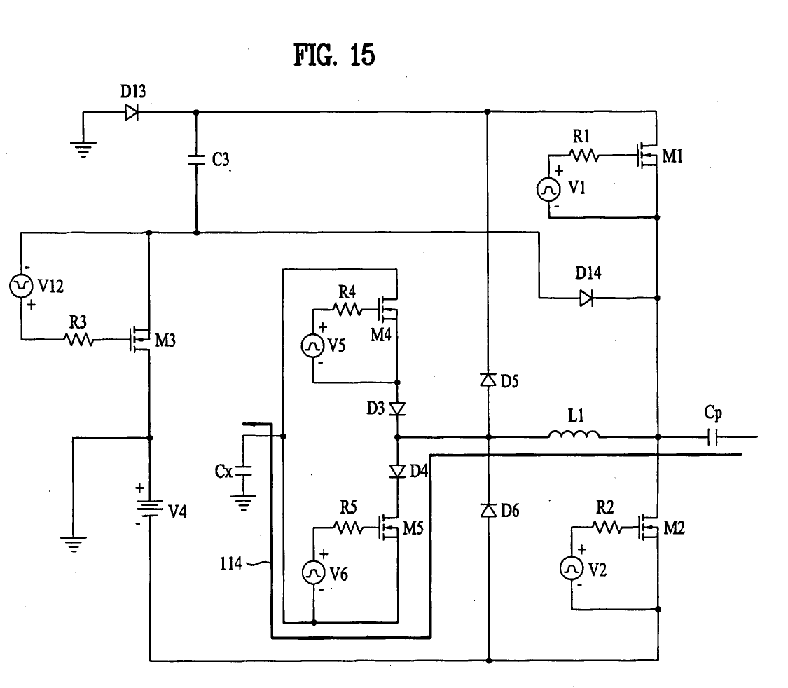

When a sustain discharge occurs subsequently in accordance with the supply of the positive sustain voltage to the panel capacitor Cp, the PDP driving apparatus of FIG. 12 recovers the discharged sustain voltage. To this end, the switch MS is turned on. As a result, a current path is established which extends from the panel capacitor Cp to the ground source via the inductor L1 and switch MS in an arrow direction 114 shown in FIG. 15.

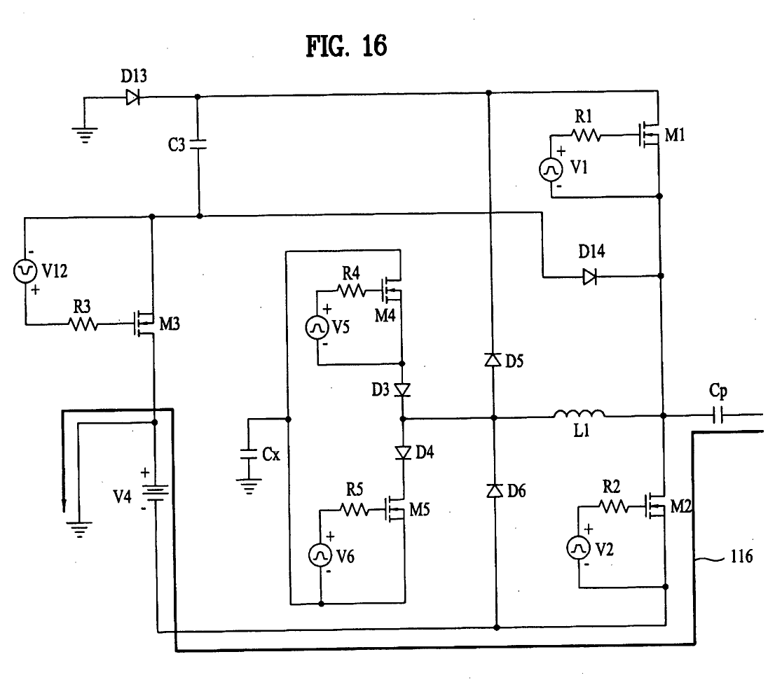

In this state, the PDP driving apparatus of FIG. 12 supplies a negative sustain voltage to the panel. To this end, a current path is established which extends from the panel capacitor Cp to the ground source via the switch M2 and sustain voltage source V4 in an arrow direction 116 shown in FIG. 16.

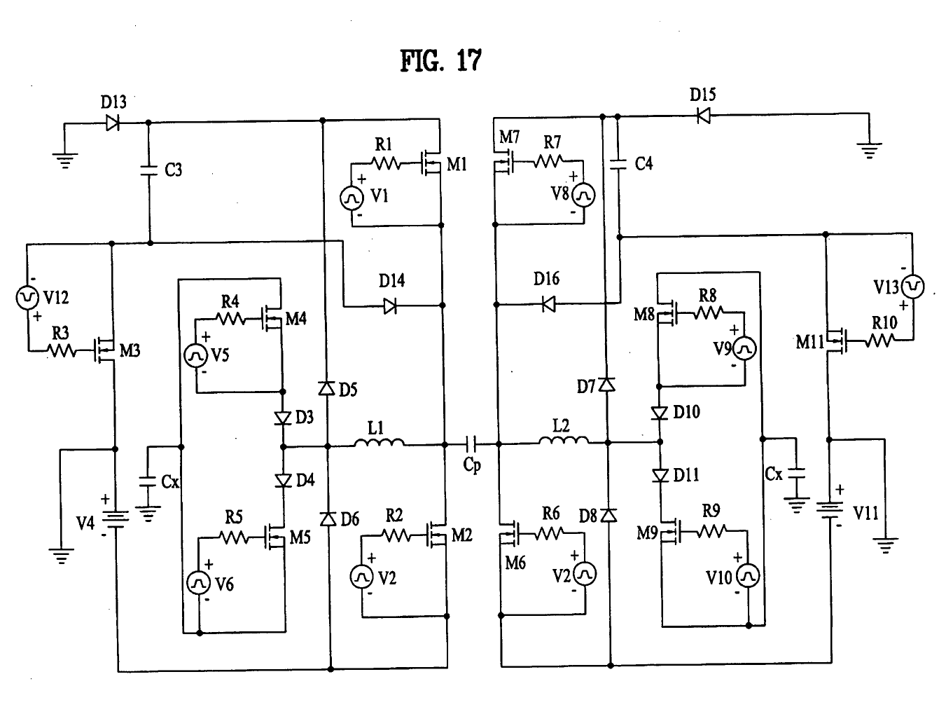

FIG. 17 is a circuit diagram illustrating a practical example of the PDP driving apparatus according to the present invention shown in FIG. 12. In this example, it is assumed that the sustain voltage component of Vs/2 is 100 V.

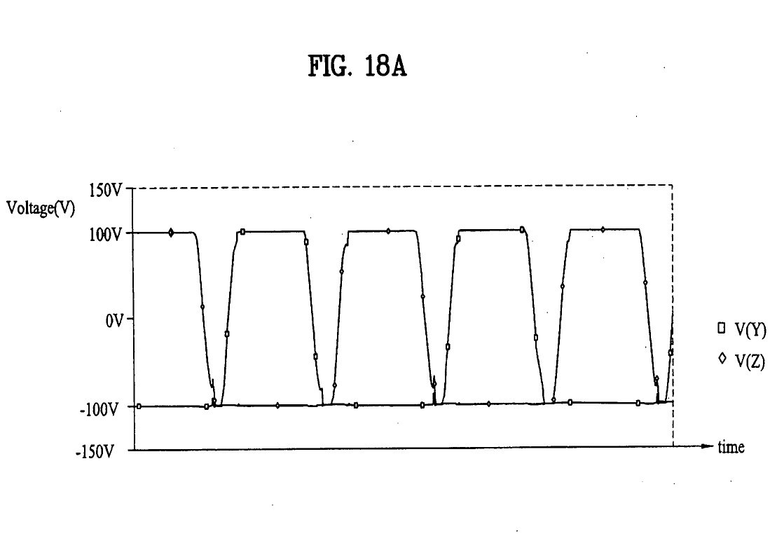

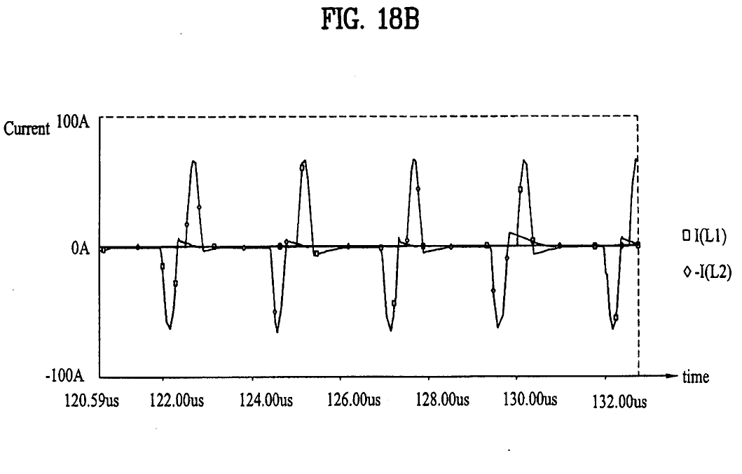

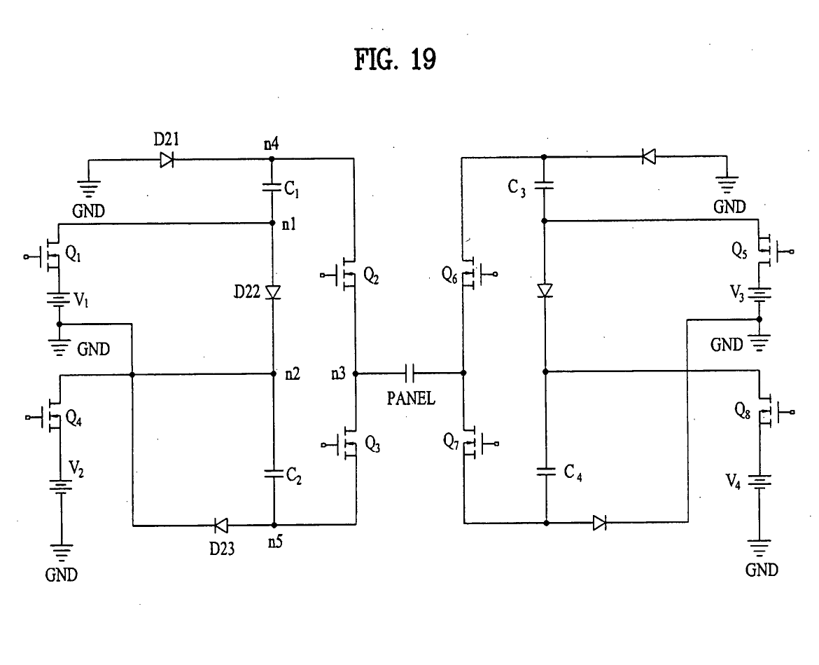

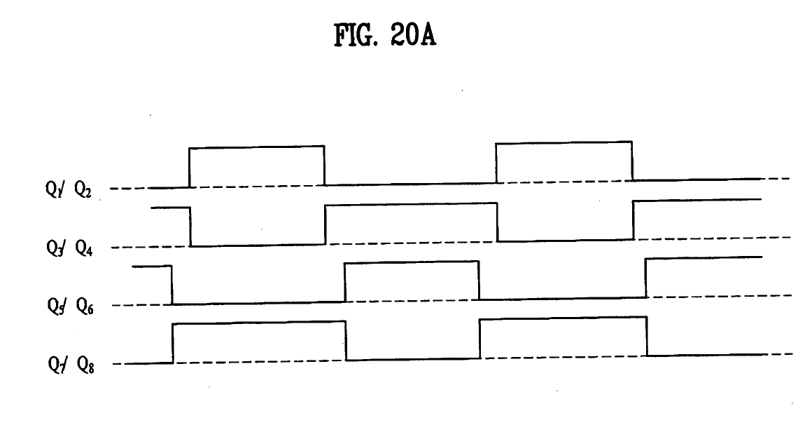

FIG. 18A is a waveform diagram of sustain pulses generated by the PDP driving apparatus of FIG. 17 according to the present invention. FIG. 18B is a waveform diagram of resonance current generated in the PDP driving apparatus of FIG. 17 according to the present invention.

“V(Y)” in FIG. 18B represents a sustain pulse supplied to the scan electrode Y. “V(Z)” in FIG. 18B represents a sustain pulse supplied to the sustain electrode Z.

FIG. 19 is a circuit diagram illustrating an apparatus for driving a plasma display panel in accordance with a fifth embodiment of the present invention.

As shown in FIG. 19, the PDP driving apparatus according to the fifth embodiment of the present invention may include first and second voltage sources V₁ and V₂, first and second capacitors C₁ and C₂, a first switching unit including switches Q₁ and Q₂, and a second switching unit including switches Q₃ and Q₄.

The first capacitor C₁ is charged with a voltage from the second voltage source V₂, or discharges the charged voltage. The second capacitor C₂ is charged with a voltage from the first voltage source V₁, or discharges the charged voltage.

The first switching unit performs a switching operation to apply the voltage from the first voltage source V₁ and the voltage from the first capacitor C₁ to the panel PANEL, and to apply a voltage to the second capacitor C₂.

The second switching unit performs a switching operation reverse to that of the first switching unit, to discharge a voltage from the panel PANEL and a voltage from the second capacitor C₂, and to apply a voltage to the first capacitor C₁.

In this case, the first and second voltage sources V₁ and V₂ supply sustain voltage components of ±Vs/4, respectively, whereas the first and second capacitors C₁ and C₂ are charged with and discharge voltages of ±Vs/4, respectively.

The first and second capacitors C₁ and C₂ are connected in series.

The first switch Q₁ of the first switching unit is electrically connected between a first node n1, between the first and second capacitors C₁ and C₂, and the first voltage source V₁. The second switch Q₂ of the first switching unit is electrically connected between the panel PANEL and the first capacitor C₁.

The third switch Q₃ of the second switching unit is electrically connected between a third node n3, between the panel PANEL and the second switch Q₂, and the second capacitor C₂. The fourth switch Q₄ of the second switching unit is electrically connected between a second node n2, between the first and second capacitors C₁ and C₂, and the second voltage source V₂.

The first diode D21 is electrically connected between a fourth node n4, between the first capacitor C₁ and the second switch Q₂, and a first ground source. The second diode D22 is electrically connected between the first node n1 and the second node n2. A third diode D23 is electrically connected between a fifth node n5, between the second capacitor C₂ and the third switch Q₃, and a second ground source.

Thus, in accordance with the present invention, the PDP driving apparatus applies a sustain pulse swing between a positive voltage and a negative voltage, to sustain electrodes formed on a plasma display panel. The PDP driving apparatus includes a scan driver and a sustain driver for driving scan electrodes formed on the plasma display panel and the sustain electrodes, respectively. An example of the scan and sustain drivers is illustrated in FIG. 19. The scan and sustain drivers shown in FIG. 19 have the same configuration. Accordingly, the following description will be described in conjunction with only the scan driver.

As shown in FIG. 19, the PDP driving apparatus according to the fifth embodiment of the present invention includes a scan driver which is composed of the first voltage source V₁ for supplying a positive voltage, first capacitor C₁, and second capacitor C₂.

In the scan driver, the first voltage source V₁ charges the second capacitor C₂ when the positive voltage is supplied, whereas the second voltage source V₂ charges the first capacitor C₁ when the negative voltage is supplied. In this case, the voltage supplied from the first voltage source V₁ has a level corresponding to ½ of the positive voltage. The voltage supplied from the second voltage source V₂ has a level corresponding to ½ of the negative voltage. The potential difference between the positive voltage and the negative voltage is the sustain discharge voltage.

In the fifth embodiment of the present invention, the voltages respectively charged in the first and second capacitors C₁ and C₂ are identical to each other, and are ½ of the positive or negative voltage.

In accordance with the fifth embodiment of the present invention, the scan driver further includes the first switch Q₁, and the second switch Q₂ for controlling supply of the positive voltage to the sustain electrode. The first and second switches Q₁ and Q₂ are simultaneously turned on or off.

In accordance with the fifth embodiment of the present invention, the scan driver further includes the third switch Q₃ for controlling supply of the voltage from the second voltage source V₂, and the fourth switch Q₄ for controlling supply of the negative voltage to the sustain electrode. The third and fourth switches Q₃ and Q₄ are simultaneously turned on or off.

In FIG. 19, the constituent elements of the sustain driver, namely, voltage sources V₃ and V₄, capacitors C₃ and C₄, and switches Q₅ to Q₈, correspond to the voltage sources V₁ and V₂, capacitors C₁ and C₂, and switches Q₁ to Q₄ of the scan driver, respectively.

Hereinafter, the operation characteristics of the PDP driving apparatus according to the fifth embodiment of the present invention will be described.

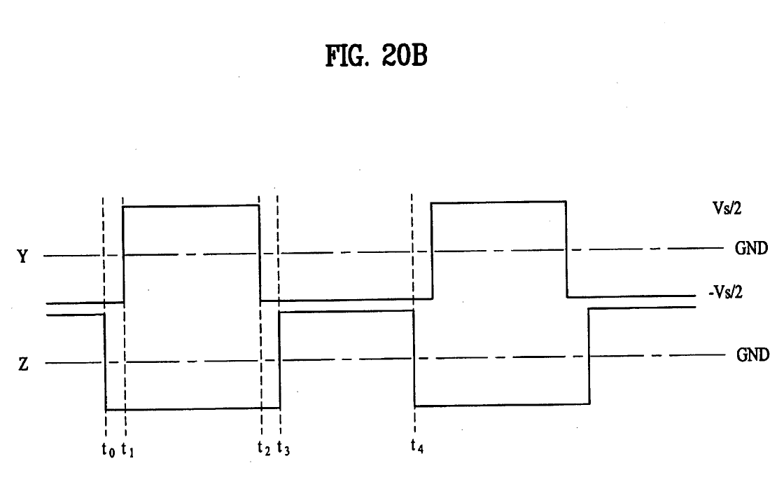

FIG. 20A is a timing diagram of turn-on and turn-off states of the switches shown in FIG. 19. FIG. 20B is a waveform diagram of signals output in accordance with the timings of FIG. 20A.

Referring to FIGS. 20A and 20B, at a time t₀, the fifth and sixth switches Q₅ and Q₆ are turned off. Simultaneously, the seventh and eighth switches Q₇ and Q₈ are turned on. At this time, the first and second switches Q₁ and Q₂ are in an OFF state, whereas the third and fourth switches Q3 and Q4 are in an ON state. Accordingly, the output waveform of the sustain electrode descends to the negative voltage. On the other hand, the output waveform of the scan electrode is maintained at the negative voltage.

Subsequently, at a time t₁, the first and second switches Q₁ and Q₂ are turned on. Simultaneously, the third and fourth switches Q₃ and Q₄ are turned off. At this time, the fifth and sixth switches Q5 and Q₆ are in an OFF state, whereas the seventh and eighth switches Q₇ and Q₈ are in an ON state. Accordingly, the output waveform of the scan electrode ascends to the positive voltage. On the other hand, the output waveform of the sustain electrode is maintained at the negative voltage. As a result, the negative voltage is applied to the sustain electrode, and the positive voltage is applied to the scan electrode. Thus, a sustain discharge is begun. The sustain discharge is continued until a time t₂.

At the time t₂, the first and second switches Q₁ and Q₂ are turned off. Simultaneously, the third and fourth switches Q₃ and Q₄ are turned on. At this time, the fifth and sixth switches Q₅ and Q₆ are in an OFF state, whereas the seventh and eighth switches Q₇ and Q₈ are in an ON state. Accordingly, the output waveform of the scan electrode descends to the negative voltage. On the other hand, the output waveform of the sustain electrode is maintained at the negative voltage. As a result, the sustain discharge continued until the time t₂ is completed.

Subsequently, at a time t₃, the fifth and sixth switches Q₅ and Q₆ are turned on. Simultaneously, the seventh and eighth switches Q₇ and Q₈ are turned off. At this time, the first and second switches Q₁ and Q₂ are in an OFF state, whereas the third and fourth switches Q₃ and Q₄ are in an ON state. Accordingly, the output waveform of the sustain electrode ascends to the positive voltage. On the other hand, the output waveform of the scan electrode is maintained at the negative voltage. As a result, the positive voltage is applied to the sustain electrode, and the negative voltage is applied to the scan electrode. Thus, a sustain discharge is begun. The sustain discharge is continued until a time t₄. Thus, a sustain pulse of one period is applied to the scan electrode and sustain electrode of the plasma display panel.

The voltage sources of the scan and sustain drivers in the PDP driving apparatus according to the fifth embodiment of the present invention supplies voltages of ±Vs/4. Since the voltage level of the voltage sources is lower than those of other embodiments as described above, it is possible to easily design a voltage supply circuit. The voltage sources of the scan or sustain driver can also be used for voltage source for driving address electrodes.

The voltage supply path of the sustain driver in the PDP driving apparatus according to the fifth embodiment of the present invention having the above-described effects will now be described.

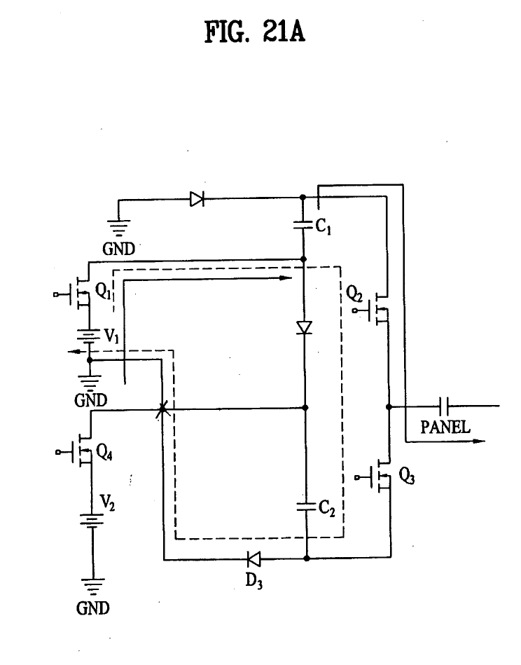

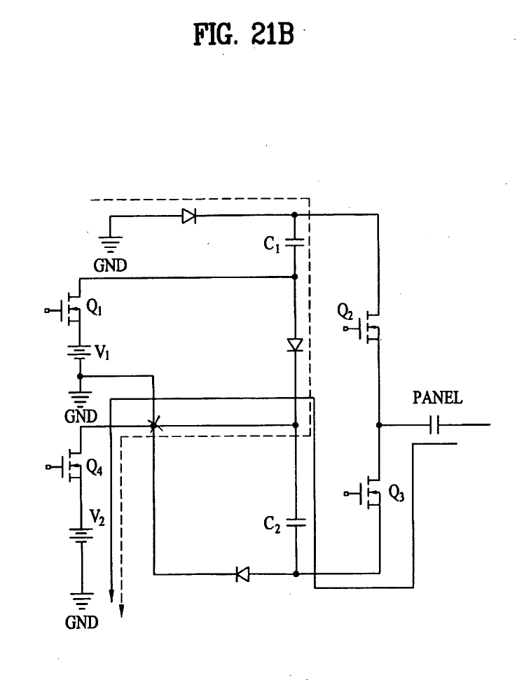

FIGS. 21A and 21B are circuit diagrams illustrating voltage supply paths of the sustain driver in the PDP driving apparatus according to the fifth embodiment of the present invention.

Referring to FIG. 21A, the voltage from the first voltage source V₁ charges the second capacitor C₂ to a level of −Vs/4 as the first and second switches Q₁ and Q₂ are turned on. Simultaneously, the charged voltage is added to the voltage of Vs/4 previously charged in the first capacitor C₁. The resulting voltage, namely, a voltage of Vs/2, is supplied to the scan electrode of the plasma display panel.

Referring to FIG. 21B, the voltage from the second voltage source V₂ charges the first capacitor C₁ to a level of Vs/4 as the third and fourth switches Q₃ and Q₄ are turned on. Simultaneously, the charged voltage is added to the voltage of −Vs/4 previously charged in the second capacitor C₂. The resulting voltage, namely, a voltage of −Vs/2, is supplied to the scan electrode of the plasma display panel.

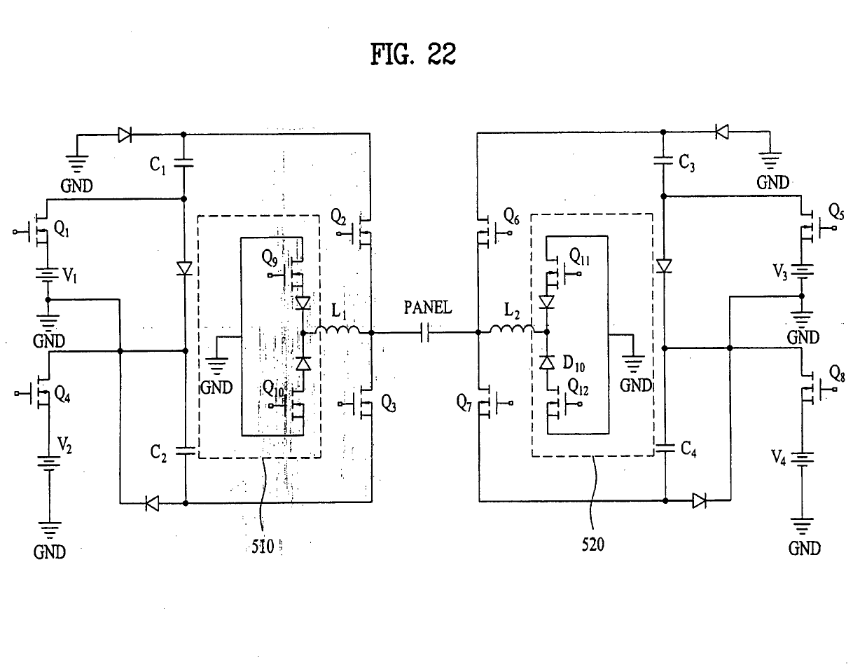

The PDP driving apparatus according to the fifth embodiment of the present invention may further include an energy supplier/recoverer, in order to more efficiently drive the plasma display panel, as shown in FIG. 22.

FIG. 22 is a circuit diagram illustrating a modified embodiment of the PDP driving apparatus according to the fifth embodiment of the present invention.

Referring to FIG. 22, the PDP driving apparatus according to the fifth embodiment of the present invention further includes energy suppliers/recoverers 510 and 520.

The energy suppliers/recoverers 510 and 520 are included in the scan and sustain drivers, respectively, and have the same configuration. For the simplicity of description, the following description will be given in conjunction with only the energy supplier/recoverer 510 included in the scan driver.

The energy supplier/recoverer 510 includes a ground voltage source GND for supplying a ground voltage, an inductor L₁ for supplying energy to the panel PANEL, and recovering energy from the panel PANEL, and an energy supply switch Q₉ and an energy recovery switch Q₁₀ for controlling the timings of operations for supply and recovery of energy.

In accordance with the above-described configuration, it is possible to recover reactive current during operation of the plasma display panel and to supply the recovered current, and thus, to achieve an enhancement in the energy efficiency of the plasma display panel.

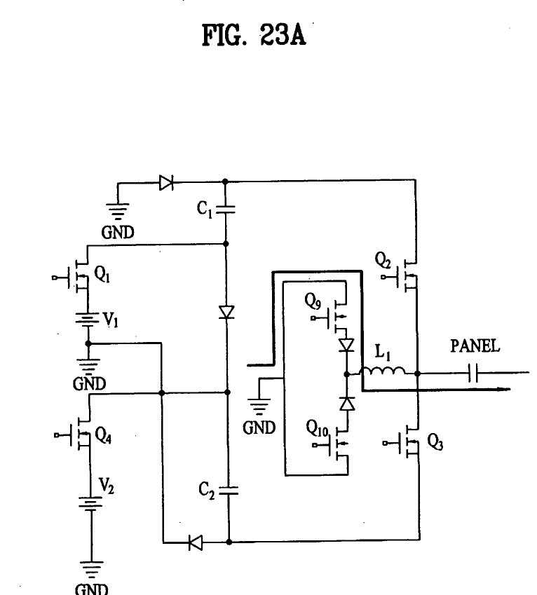

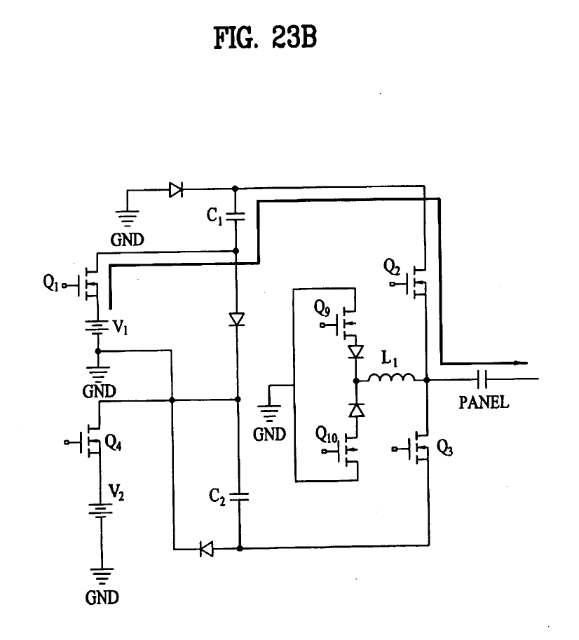

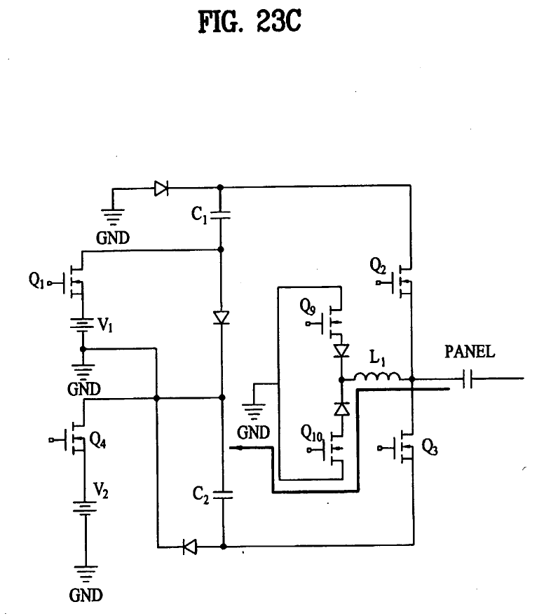

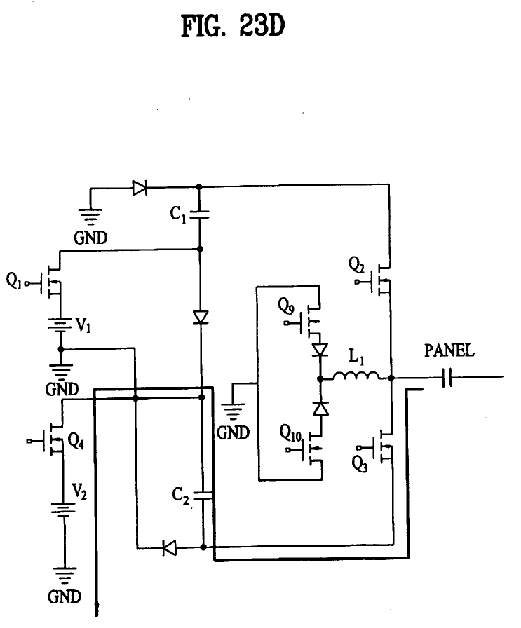

FIGS. 23A to 23D are circuit diagrams for explaining the operation characteristics of the modified embodiment of the PDP driving apparatus according to the fifth embodiment of the present invention.

Referring to FIG. 23A, when the energy supply switch Q₉ is turned on, a certain amount of energy is supplied to the panel PANEL before supply of the positive voltage.

Referring to FIG. 23B, when the first and second switches Q₁ and Q₂ are turned on, simultaneously with the energy supply switch Q₉, a certain amount of energy is supplied to the panel PANEL, and the positive voltage is supplied to the panel PANEL.

Referring to FIG. 23C, when the energy recovery switch Q₁₀ is turned on, a certain amount of energy is recovered from the panel PANEL before supply of the negative voltage.

Referring to FIG. 23D, when the third and fourth switches Q₃ and Q₄ are turned on, simultaneously with the energy recovery switch Q₁₀, a certain amount of energy is recovered, and the negative voltage is recovered from the panel PANEL.

Thus, a certain amount of energy is supplied before supply of the positive voltage, and a certain amount of energy is recovered before supply of the negative voltage. Accordingly, an enhancement of the energy efficiency of the plasma display panel is achieved. In addition, an abrupt voltage increase or drop is suppressed. Accordingly, it is possible to prevent the elements of the driving circuits from being damaged.

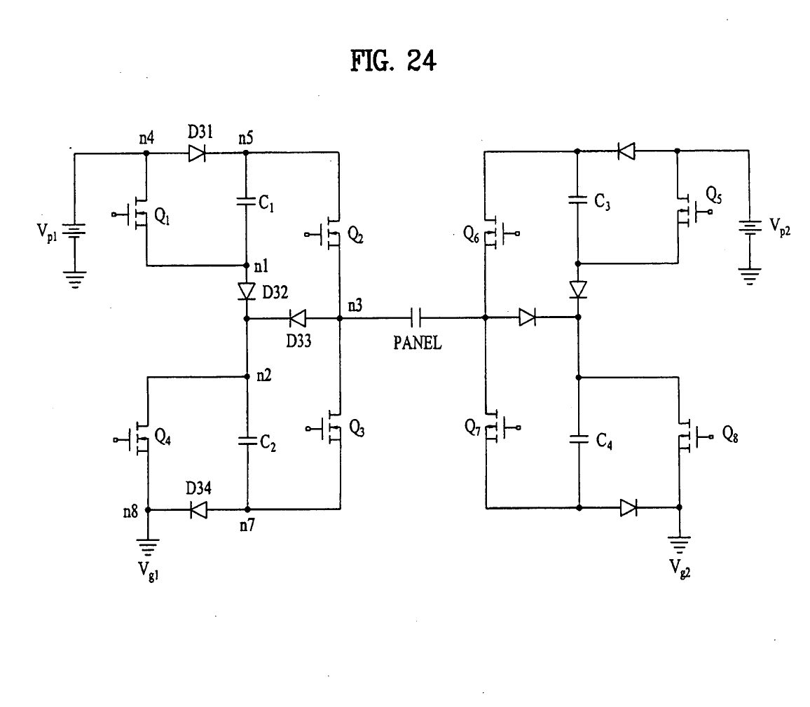

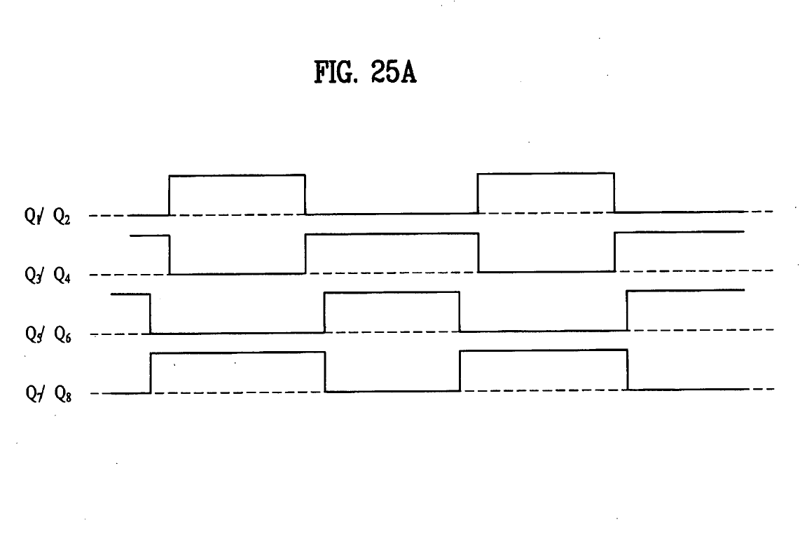

FIG. 24 is a circuit diagram illustrating a PDP driving apparatus according to a sixth embodiment of the present invention.

As shown in FIG. 24, the PDP driving apparatus includes a voltage source Vₚ₁, first and second capacitors C₁ and C₂, a first switching unit including switches Q₁ and Q₂, and a second switching unit including switches Q₃ and Q₄.

The first and second capacitors C₁ and C₂ are charged with a voltage from the voltage source Vₚ₁, or discharge the charged voltage.

The first switching unit performs a switching operation to apply the voltage from the voltage source Vₚ₁ and the voltage from the first capacitor C₁ to the panel PANEL, and to apply a voltage to the second capacitor C₂.

The second switching unit performs a switching operation reverse to that of the first switching unit, to discharge a voltage from the panel PANEL and a voltage from the second capacitor C₂, and to apply a voltage to the first capacitor C₁.

The voltage source Vₚ₁ supplies sustain voltage components of ±Vs/4. The first and second capacitors C₁ and C₂ are charged with and discharge voltages of ±Vs/4.

The first and second capacitors C₁ and C₂ are connected in series.

The first switch Q₁ of the first switching unit is electrically connected between a first node n1, between the first and second capacitors C₁ and C₂, and the voltage source Vₚ₁. The second switch Q₂ of the first switching unit is electrically connected between the panel PANEL and the first capacitor C₁. The third switch Q₃ of the second switching unit is electrically connected between a third node n3, between the panel PANEL and the second switch Q₂, and the second capacitor C₂. The fourth switch Q₄ of the second switching unit is electrically connected between a second node n2, between the first and second capacitors C₁ and C₂, and a ground source.

The first capacitor C₁ and first and second switches Q₁ and Q₂ are connected in parallel. The second capacitor C₂ and third and fourth switches Q₃ and Q₄ are connected in parallel.

The first diode D31 is electrically connected between a fourth node n4, between the voltage source Vₚ₁ and the first switch Q₁, and a fifth node n5, between the first capacitor C₁ and the second switch Q2. The second diode D32 is electrically connected between the first node n1 and the second node n2. A third diode D33 is electrically connected between a sixth node n6, between the second diode D32 and the second node n2, and the third node n3. A fourth diode D34 is electrically connected between a seventh node n7, between the second capacitor C₂ and the third switch Q₃, and an eighth node n8, between the fourth switch Q₄ and the ground source.

Thus, the PDP driving apparatus according to the sixth embodiment of the present invention applies a sustain pulse swing between a positive voltage and a negative voltage, to sustain electrodes formed on a plasma display panel. The PDP driving apparatus includes a scan driver and a sustain driver for driving scan electrodes formed on the plasma display panel and the sustain electrodes, respectively. An example of the scan and sustain drivers is illustrated in FIG. 24. The scan and sustain drivers shown in FIG. 24 have the same configuration. Accordingly, the following description will be described in conjunction with only the scan driver.

As shown in FIG. 24, the PDP driving apparatus according to the sixth embodiment of the present invention includes a scan driver which is composed of the positive voltage source Vₚ₁ for supplying a positive voltage, the first capacitor C₁, a ground voltage source V_{g1} for supplying a negative voltage, and the second capacitor C₂.

In the scan driver, the positive voltage source Vₚ₁ charges the second capacitor C₂ when the positive voltage is supplied, and charges the first capacitor C₁ when the negative voltage is supplied. In this case, the voltage supplied from the positive voltage source Vₚ₁ has a level corresponding to ½ of the positive voltage. The levels of the voltages respectively charged in the first and second capacitors C₁ and C₂ are different from each other. That is, the voltage charged in the first capacitor C₁ has a level corresponding to ½ of the level of the voltage charged in the second capacitor C₂. The level of the voltage charged in the second capacitor C₂ is identical to the level of the negative voltage. The potential difference between the positive voltage and the negative voltage is the sustain discharge voltage.

In accordance with the sixth embodiment of the present invention, the scan driver further includes the first switch Q₁, and the second switch Q2 for controlling supply of the voltage from the positive voltage source Vₚ₁. The first and second switches Q₁ and Q₂ are simultaneously turned on or off.

In accordance with the sixth embodiment of the present invention, the scan driver further includes the third switch Q₃ for controlling the ground voltage source Vg1, and the fourth switch Q₄ for controlling supply of the negative voltage to the sustain electrode. The third and fourth switches Q₃ and Q₄ are simultaneously turned on or off.

In FIG. 24, the constituent elements of the sustain driver, namely, voltage sources Vₚ₂ and V_{g2}, capacitors C₃ and C₄, and switches Q₅ to Q₈, correspond to the voltage sources Vₚ₁ and V_{g1}, capacitors C₁ and C₂, and switches Q₁ to Q₄ of the scan driver, respectively.

Hereinafter, the operation characteristics of the PDP driving apparatus according to the sixth embodiment of the present invention will be described.

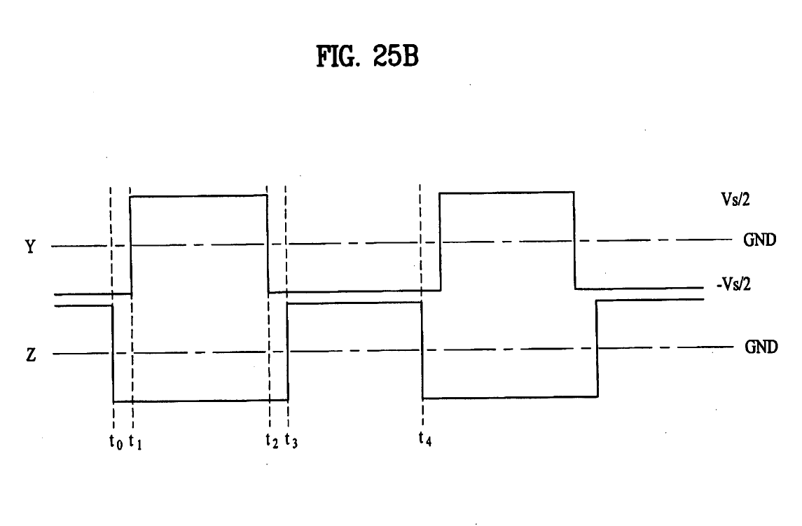

FIG. 25A is a timing diagram of turn-on and turn-off states of the switches shown in FIG. 24. FIG. 25B is a waveform diagram of signals output in accordance with the timings of FIG. 25A.

Referring to FIGS. 25A and 25B, at a time t₀, the fifth and sixth switches Q₅ and Q₆ are turned off. Simultaneously, the seventh and eighth switches Q₇ and Q₈ are turned on. At this time, the first and second switches Q₁ and Q₂ are in an OFF state, whereas the third and fourth switches Q₃ and Q₄ are in an ON state. Accordingly, the output waveform of the sustain electrode descends to the negative voltage. On the other hand, the output waveform of the scan electrode is maintained at the negative voltage.

Subsequently, at a time t₁, the first and second switches Q₁ and Q₂ are turned on. Simultaneously, the third and fourth switches Q₃ and Q₄ are turned off. At this time, the fifth and sixth switches Q₅ and Q₆ are in an OFF state, whereas the seventh and eighth switches Q₇ and Q₈ are in an ON state. Accordingly, the output waveform of the scan electrode ascends to the positive voltage. On the other hand, the output waveform of the sustain electrode is maintained at the negative voltage. As a result, the negative voltage is applied to the sustain electrode, and the positive voltage is applied to the scan electrode. Thus, a sustain discharge is begun. The sustain discharge is continued until a time t₂.

At the time t₂, the first and second switches Q₁ and Q₂ are turned off. Simultaneously, the third and fourth switches Q₃ and Q₄ are turned on. At this time, the fifth and sixth switches Q₅ and Q₆ are in an OFF state, whereas the seventh and eighth switches Q₇ and Q₈ are in an ON state. Accordingly, the output waveform of the scan electrode descends to the negative voltage. On the other hand, the output waveform of the sustain electrode is maintained at the negative voltage. As a result, the sustain discharge is continued until the time t₂ is completed.

Subsequently, at a time t₃, the fifth and sixth switches Q₅ and Q₆ are turned on. Simultaneously, the seventh and eighth switches Q₇ and Q₈ are turned off. At this time, the first and second switches Q₁ and Q₂ are in an OFF state, whereas the third and fourth switches Q₃ and Q₄ are in an ON state. Accordingly, the output waveform of the sustain electrode ascends to the positive voltage. On the other hand, the output waveform of the scan electrode is maintained at the negative voltage. As a result, the positive voltage is applied to the sustain electrode, and the negative voltage is applied to the scan electrode. Thus, a sustain discharge is begun. The sustain discharge is continued until a time t₄. Thus, a sustain pulse of one period is applied to the scan electrode and sustain electrode of the plasma display panel.

The voltage sources of the scan and sustain drivers in the PDP driving apparatus according to the sixth embodiment of the present invention supply a voltage of Vs/4. Since the voltage level of the voltage sources is lower than those of other embodiments as described above, it is possible to easily design a voltage supply circuit. The voltage sources of the scan or sustain driver can also be used for voltage source for driving address electrodes. In accordance with the sixth embodiment of the present invention, the voltage of −Vs/4 is not supplied, differently from the fifth embodiment of the present invention supplying voltages of ±Vs/4. Accordingly, it is possible to more easily design desired circuits, and to further reduce the manufacturing costs of the plasma display panel.

The voltage supply path of the sustain driver in the PDP driving apparatus according to the sixth embodiment of the present invention having the above-described effects will now be described.

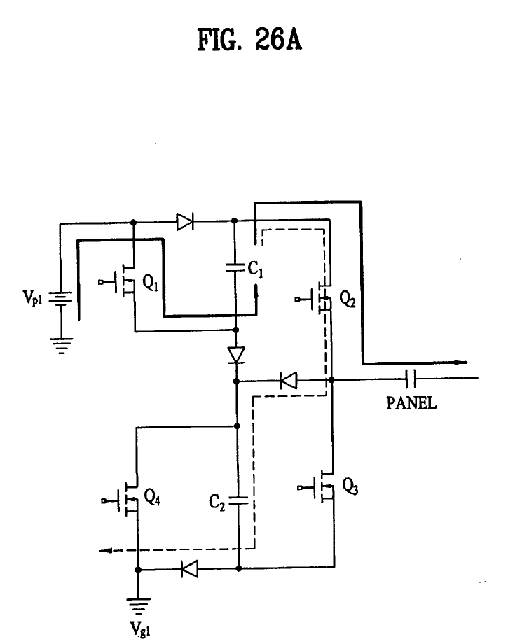

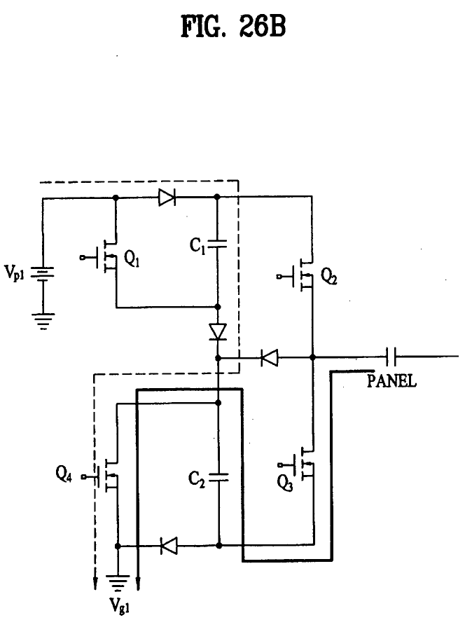

FIGS. 26A and 26B are circuit diagrams illustrating voltage supply paths of the sustain driver in the PDP driving apparatus according to the sixth embodiment of the present invention.

Referring to FIG. 26A, the voltage from the positive voltage source Vₚ₁ is added to the voltage of Vs/4 previously charged in the first capacitor C₁ when the first and second switches Q₁ and Q₂ are turned on. The resulting voltage, namely, a voltage of Vs/2, is supplied to the scan electrode of the plasma display panel. Simultaneously, a voltage of −Vs/2 is charged in the second capacitor C₂.

Referring to FIG. 26B, a current path extending from the panel PANEL to the ground voltage source V_{g1} is established when the third and fourth switches Q₃ and Q₄ are turned on. Accordingly, the voltage of −Vs/2 charged in the second capacitor C₂ is supplied to the panel PANEL. Simultaneously, a voltage of Vs/4 is charged in the first capacitor C₁ because the positive voltage source Vₚ₁ and ground voltage source V_{g1} form different current paths, respectively.

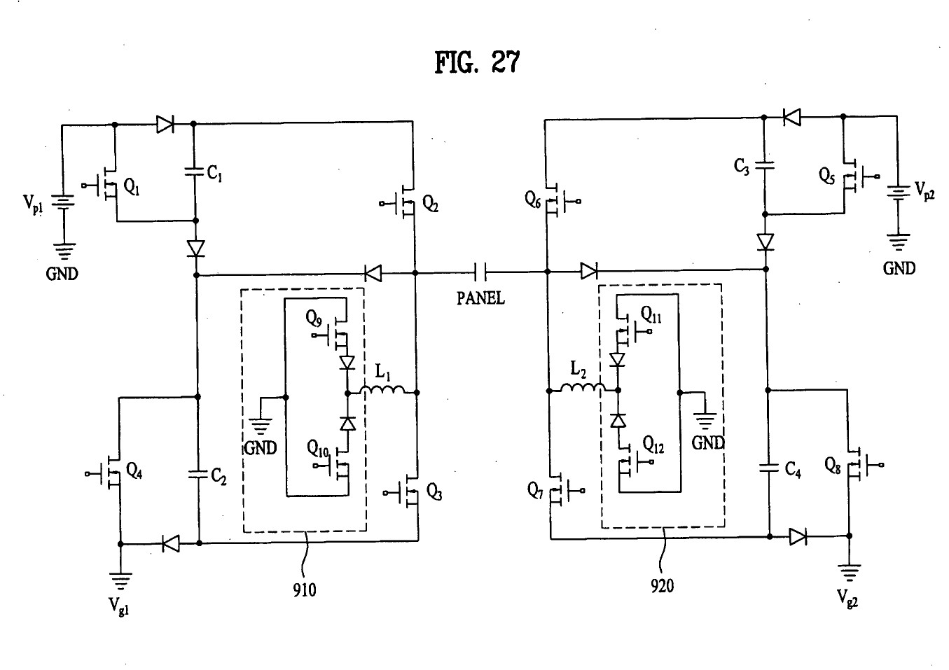

The PDP driving apparatus according to the sixth embodiment of the present invention may further include an energy supplier/recoverer, in order to more efficiently drive the plasma display panel, as shown in FIG. 27.

FIG. 27 is a circuit diagram illustrating a modified embodiment of the PDP driving apparatus according to the sixth embodiment of the present invention.

Referring to FIG. 27, the PDP driving apparatus according to the sixth embodiment of the present invention further includes energy suppliers/recoverers 910 and 920.

The energy suppliers/recoverers 910 and 920 are included in the scan and sustain drivers, respectively, and have the same configuration. For the simplicity of description, the following description will be given in conjunction with only the energy supplier/recoverer 910 included in the scan driver.

The energy supplier/recoverer 910 includes a ground voltage source GND for supplying a ground voltage, an inductor L₁ for supplying energy to the panel PANEL, and recovering energy from the panel PANEL, and an energy supply switch Q₉ and an energy recovery switch Q₁₀ for controlling the timings of operations for supply and recovery of energy.

In accordance with the above-described configuration, it is possible to recover reactive current during operation of the plasma display panel and to supply the recovered current, and thus, to achieve an enhancement in the energy efficiency of the plasma display panel.

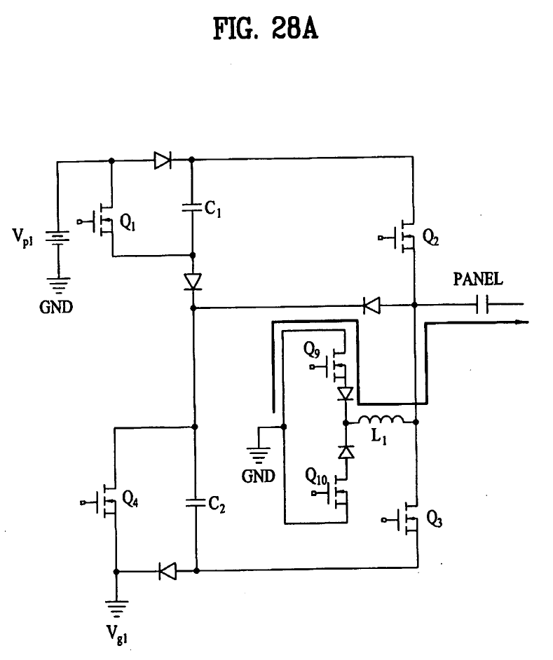

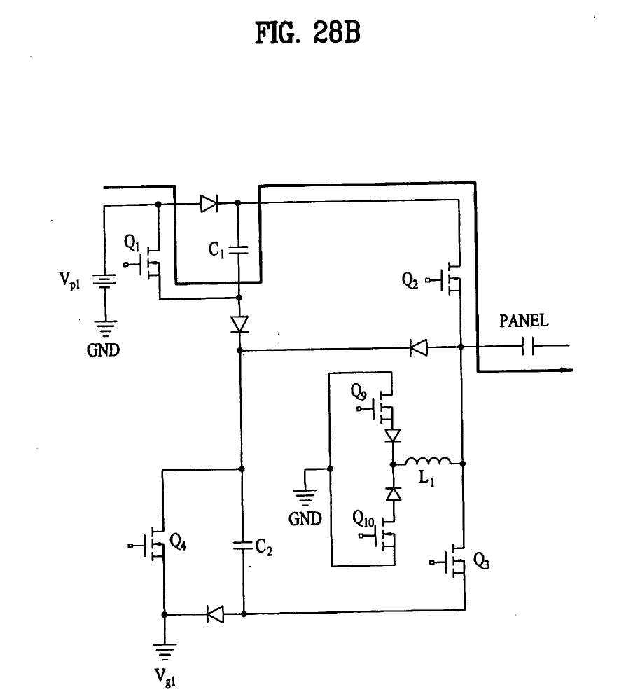

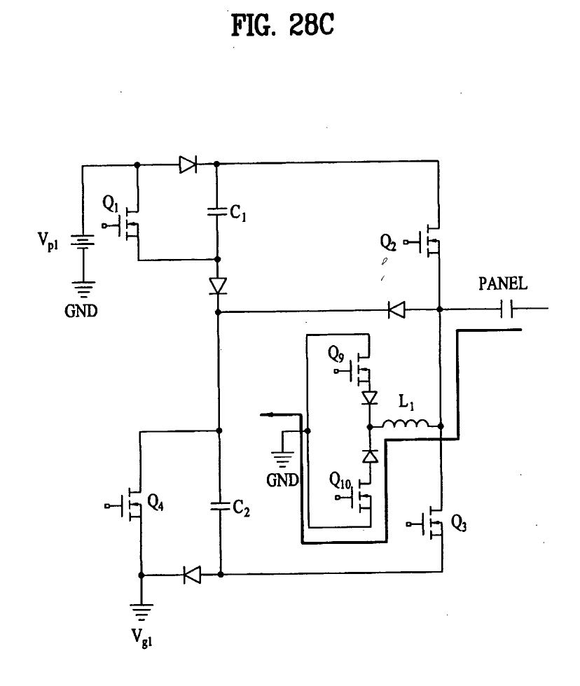

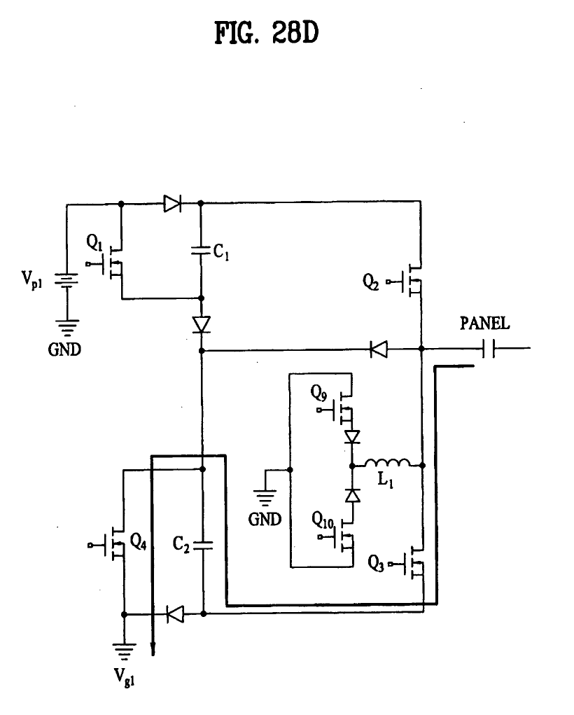

FIGS. 28A to 28D are circuit diagrams for explaining the operation characteristics of the modified embodiment of the PDP driving apparatus according to the sixth embodiment of the present invention.

Referring to FIG. 28A, when the energy supply switch Q9 is turned on, a certain amount of energy is supplied to the panel PANEL before supply of the positive voltage.

Referring to FIG. 28B, when the first and second switches Q₁ and Q₂ are turned on, simultaneously with the energy supply switch Q₉, a certain amount of energy is supplied to the panel PANEL, and the positive voltage is supplied to the panel PANEL.

Referring to FIG. 28C, when the energy recovery switch Q₁₀ is turned on, a certain amount of energy is recovered from the panel PANEL before supply of the negative voltage.

Referring to FIG. 28D, when the third and fourth switches Q₃ and Q₄ are turned on, simultaneously with the energy recovery switch Q₁₀, a certain amount of energy is recovered, and the negative voltage is recovered from the panel PANEL.

Thus, a certain amount of energy is supplied before supply of the positive voltage, and a certain amount of energy is recovered before supply of the negative voltage. Accordingly, an enhancement of the energy efficiency of the plasma display panel is achieved. In addition, an abrupt voltage increase or drop is suppressed. Accordingly, it is possible to prevent the elements of the driving circuits from being damaged.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As apparent from the above description, in accordance with the present invention, it is possible to reduce the power consumption of the PDP driving apparatus, and thus, to achieve an enhancement in energy efficiency.

In accordance with the present invention, the internal voltage of the PDP driving apparatus is reduced. Accordingly, it is possible to suppress damage of the elements of the driving apparatus, and to reduce the manufacturing costs.

Where the plasma display panel is driven using a single voltage source in accordance with the half sustain driving scheme, the PDP driving apparatus and method according to the present invention can reduce the number of switches used to generate a sustain pulse, and thus, to reduce the costs required to configure desired circuits.

In accordance with the present invention, loss of current and distortion of waveforms occurring during the generation of the sustain pulse are reduced. By virtue of the reduced number of switches, it is possible to achieve easy switch control, and thus, to achieve an enhancement in the reliability and efficiency of the circuits.

What is claimed is:

1. An apparatus for driving a plasma display panel, comprising:
a voltage source;
a capacitor charged with a voltage supplied from the voltage source, or discharging the charged voltage;
a first switching unit for performing a switching operation to apply the voltage from the voltage source to the capacitor and a panel, or to apply the charged voltage from the capacitor to the panel; and
a second switching unit for performing a switching operation reverse to the switching operation of the first switching unit, to discharge a voltage from the panel and to discharge the charged voltage from the capacitor, or to apply the voltage from the voltage source to the capacitor and to discharge the voltage from the panel.

2. The apparatus according to claim 1, wherein the voltage supplied from the voltage source is ±½ of a sustain voltage.

3. The apparatus according to claim 1, wherein each of the first and second switching units comprises one or two switches.

4. The apparatus according to claim 1, wherein the capacitor is charged with and discharges a voltage corresponding to ±½ of a sustain voltage.

5. The apparatus according to claim 1, further comprising:
an energy recoverer electrically connected between the first switching unit and the second switching unit, to recover the voltage from the panel and to supply the recovered voltage to the panel.

6. An apparatus for driving a plasma display panel, comprising:
a voltage source;
a first switch for performing a switching operation to apply a voltage from the voltage source to a panel;
a capacitor charged with a voltage supplied from the voltage source in accordance with the switching operation of the first switch; and
a second switch and a third switch for performing a switching operation reverse to the switching operation of the first switch, to discharge a voltage from the panel and to discharge the charged voltage from the capacitor.

7. The apparatus according to claim 6, wherein:
the first switch is electrically connected between the voltage source and the panel;
the second switch is electrically connected between a fourth node, between the first switch and the panel, and a ground source;
the capacitor is electrically connected between a third node, between the second switch and the ground source, and a first node, between the first switch and the panel;
the third switch is electrically connected between a second node, between the first switch and the capacitor, and a fifth node, between the second switch and the ground source.

8. The apparatus according to claim 7, wherein the capacitor and the third switch are connected in parallel.

9. The apparatus according to claim 7, further comprising:
a first diode electrically connected between the first node and the second node; and
a second diode electrically connected between the third node and the fifth node.

10. The apparatus according to claim 6, further comprising:
an energy recoverer electrically connected to a node between the panel and the second switch, to recover the voltage from the panel and to supply the recovered voltage to the panel.

11. The apparatus according to claim 10, wherein the energy recoverer comprises:
an inductor electrically connected to the panel;
a first recovery switch and a second recovery switch electrically connected between the inductor and a ground source; and
a third diode and a fourth diode connected in series between the first recovery switch and the second recovery switch.

12. An apparatus for driving a plasma display panel, comprising:
a voltage source;
a first switch for performing a switching operation to apply a negative voltage from the voltage source to a panel;
a capacitor charged with a positive voltage in accordance with the switching operation of the first switch; and
a second switch and a third switch for performing a switching operation reverse to the switching operation of the first switch, to apply the charged voltage from the capacitor to the panel.

13. The apparatus according to claim 12, wherein:
the first switch is electrically connected between the panel and the voltage source;
the second switch is electrically connected between a first node, between the panel and the first switch, and a first ground source;
the capacitor is electrically connected between a second node, between the second switch and the first ground source, and the first node;
the third switch is electrically connected between a third node, between the capacitor and the first node, and a second ground source.

14. The apparatus according to claim 13, wherein the capacitor and the second switch are connected in parallel.

15. The apparatus according to claim 13, further comprising:
a first diode electrically connected between the first ground source and the second node; and
a second diode electrically connected between the first node and the third node.

16. The apparatus according to claim 12, further comprising:
an energy recoverer electrically connected to a node between the panel and the first switch, to recover the voltage from the panel and to supply the recovered voltage to the panel.

17. The apparatus according to claim 16, wherein the energy recoverer comprises:
an external capacitor charged with the recovered voltage;
an inductor electrically connected to the panel;
a plurality of switches connected in parallel between the inductor and the external capacitor; and
a plurality of diodes connected in series among the switches.

18. An apparatus for driving a plasma display panel, comprising:
a voltage source;
a first capacitor and a second capacitor charged with a voltage supplied from the voltage source, or discharging the charged voltage;
a first switching unit for performing a switching operation to apply the voltage from the voltage source and the charged voltage from the first capacitor to a panel, or to apply the voltage from the voltage source to the second capacitor; and
a second switching unit for performing a switching operation reverse to the switching operation of the first switching unit, to discharge a voltage from the panel and to discharge the charged voltage from the second capacitor, or to apply the voltage from the voltage source to the first capacitor.

19. The apparatus according to claim 18, wherein the voltage supplied from the voltage source is ±¼ of a sustain voltage.

20. The apparatus according to claim 18, wherein each of the first and second capacitors is charged with and discharges a voltage corresponding to ±¼ of a sustain voltage.

21. The apparatus according to claim 18, wherein the first capacitor and the second capacitor are connected in series.

22. The apparatus according to claim 18, wherein:
the first switching unit comprises a first switch electrically connected between a first node, between the first capacitor and the second capacitor, and the voltage source, and a second switch electrically connected between the panel and the first capacitor; and
the second switching unit comprises a third switch electrically connected between a third node, between the panel and the second switch, and the second capacitor, and a fourth switch electrically connected between a second node, between the first capacitor and the second capacitor, and a ground source.

23. The apparatus according to claim 22, wherein:
the first capacitor, the first switch, and the second switch are connected in parallel; and
the second capacitor, the third switch, and the fourth switch are connected in parallel.

24. The apparatus according to claim 22, further comprising:
a first diode electrically connected between a fourth node, between the voltage source and the first switch, and a fifth node, between the first capacitor and the second switch;
a second diode electrically connected between the first node and the second node;
a third diode electrically connected between a sixth node, between the second diode and the second node, and the third node; and
a fourth diode electrically connected between a seventh node, between the second capacitor and the third switch, and an eighth node, between the fourth switch and the ground source.

25. The apparatus according to claim 18, further comprising:
an energy recoverer electrically connected between the first switching unit and the second switching unit, to recover the voltage from the panel and to supply the recovered voltage to the panel.

26. The apparatus according to claim 25, wherein the energy recoverer comprises:
an inductor electrically connected to the panel;
a plurality of switches connected in parallel between the inductor and a ground source; and
a plurality of diodes connected in series among the switches.

27. An apparatus for driving a plasma display panel, comprising:
a first voltage source and a second voltage source;
a first capacitor charged with a voltage supplied from the second voltage source, or discharging the charged voltage;
a second capacitor charged with a voltage supplied from the first voltage source, or discharging the charged voltage;
a first switching unit for performing a switching operation to apply the voltage from the first voltage source and the charged voltage from the first capacitor to a panel, or to apply the voltage from the first voltage source to the second capacitor; and
a second switching unit for performing a switching operation reverse to the switching operation of the first switching unit, to discharge a voltage from the panel and to discharge the charged voltage from the second capacitor, or to apply the voltage from the second voltage source to the first capacitor.

28. The apparatus according to claim 27, wherein the voltage supplied from each of the first and second voltage sources is ±¼ of a sustain voltage.

29. The apparatus according to claim 27, wherein each of the first and second capacitors is charged with and discharges a voltage corresponding to ±¼ of a sustain voltage.

30. The apparatus according to claim 27, wherein the first capacitor and the second capacitor are connected in series.

31. The apparatus according to claim 27, wherein:
the first switching unit comprises a first switch electrically connected between a first node, between the first capacitor and the second capacitor, and the first voltage source, and a second switch electrically connected between the panel and the first capacitor; and
the second switching unit comprises a third switch electrically connected between a third node, between the panel and the second switch, and the second capacitor, and a fourth switch electrically connected between a second node, between the first capacitor and the second capacitor, and the second ground source.

32. The apparatus according to claim 31, further comprising:
a first diode electrically connected between a fourth node, between the first capacitor and the second switch, and a first ground source;
a second diode electrically connected between the first node and the second node; and
a third diode electrically connected between a fifth node, between the second capacitor and the third switch, and a second ground source.

33. The apparatus according to claim 27, further comprising:
an energy recoverer electrically connected between the first switching unit and the second switching unit, to recover the voltage from the panel and to supply the recovered voltage to the panel.

34. The apparatus according to claim 33, wherein the energy. recoverer comprises:
an inductor electrically connected to the panel;
a plurality of switches connected in parallel between the inductor and a ground source; and
a plurality of diodes connected in series among the switches.
